(19) United States
(12) Patent Application Publication
(10) Pub. No.: US 2014/0067406 A1
(43) Pub. Date: Mar. 6, 2014

(54) FACILITATING A TRANSACTION AMONG A SURGICAL PROVIDER, AN ITEM PROVIDER, AND A PAYOR

(71) Applicants: Eugene A. Hyatt, Lawrenceville, GA (US); Todd A. Rielly, Alpharetta, GA (US); David C. Palmer, Roswell, GA (US); Richard B. Mills, Cartersville, GA (US); Martin W. Smith, Roswell, GA (US)

(72) Inventors: Eugene A. Hyatt, Lawrenceville, GA (US); Todd A. Rielly, Alpharetta, GA (US); David C. Palmer, Roswell, GA (US); Richard B. Mills, Cartersville, GA (US); Martin W. Smith, Roswell, GA (US)

(21) Appl. No.: 13/599,696

(22) Filed: Aug. 30, 2012

(51) Int. Cl. G06Q 50/22

(52) U.S. Cl. CPC G06Q 50/22; G06Q 30/0283
USPC 705/2

(57) ABSTRACT

Methods and systems using a computer system for facilitating a transaction among a surgical provider, a medical device provider, and a payor are disclosed. A cost to provide medical devices needed for an identified procedure is estimated. Revenue to an entity that controls the computer system may also be estimated. Medical devices actually used in the surgical procedure are identified. A request may be submitted to the payor for reimbursement of costs associated with the devices actually used.

### BACKGROUND

As should be understood, medical procedures cover a broad range of activity, for instance from physicals and check-ups to surgical procedures that require medical devices be surgically implanted into the patient's body. Examples of such devices may include titanium pins, titanium screws, titanium joints (for hips, knees, etc.), and other biomedically engineered devices, and human tissue. Other medical devices, e.g. tools and disposable materials such as bandages, dressings and surgical masks that are not left permanently in the patient's body, may also be used.

When a patient is admitted to a medical facility or plans for surgery, the patient often provides information identifying a party responsible for payment of the cost for the procedure and needed implantable medical devices, most often medical insurer and/or the patient himself or herself.

Prior to surgery, the physician/surgeon notifies the surgery facility, e.g. a hospital or non-hospital surgery center, of the surgery date and the surgical procedure to be performed, and provides diagnosis information. The surgeon may or may not specifically identify implantable medical devices needed for the surgery, but in any event, the surgical facility assesses the need for such devices based on the provided information. The surgery facility may have the needed devices in its available inventory but may also need to order devices from a medical device provider. Surgical facilities may also have medical device provider representatives on hand during surgery to provide medical devices in the event devices are unexpectedly needed during surgery.

### SUMMARY

The present invention recognizes and addresses one or more of the foregoing considerations, and possible others, of prior art constructions and methods.

In one embodiment of a method for facilitating a transaction among a surgical provider, a medical device provider, and a payor, involving medical devices needed for a surgical procedure to be conducted by the surgical provider, procedure identification and diagnosis information related to the surgical procedure is received from a surgical provider of a plurality of surgical providers at a computer system that is accessible by the plurality of surgical providers remote from the computer system. At the computer system, one or more medical devices for use in the surgical procedure is predicted based on the procedure information and the diagnosis information. At the computer system, a cost is estimated for an entity that controls the computer system to provide medical devices to the surgical provider, based on at least one of the one or more medical devices predicted at the predicting step and the procedure identification information received at the receiving step. At the computer, a revenue amount to the entity is estimated, based on a predetermined reimbursement relationship between the entity and at least one of the payor and the surgical provider. At the computer system, information from the surgical provider is received identifying medical devices actually used in the surgical procedure after the surgical procedure has been performed. From the computer system, instructions to reimburse the surgical provider costs borne by the surgical provider for medical devices actually used in the surgical procedure are transmitted. From the computer system, a request is submitted to the payor for reimbursement of the entity for costs borne by the entity for medical devices actually used in the surgical procedure.

In a further embodiment, a computer system has a computer processor, a computer-readable medium, and one or more software modules stored on the computer-readable medium, the modules being configured to perform a method of facilitating a transaction among a surgical provider, a medical device provider, and a payor, involving medical devices needed for a surgical procedure to be conducted by the surgical provider. The method includes receiving, from a surgical provider of a plurality of surgical providers, procedure identification and diagnosis information related to the surgical procedure. One or more medical devices is predicted for use in the surgical procedure based on the procedure information and the diagnosis information. A cost is estimated for an entity that controls the computer system to provide medical devices to the surgical provider, based on at least one of the one or more medical devices predicted at the predicting step and the procedure identification information received at the receiving step. A revenue is estimated to the entity based on a predetermined reimbursement relationship between the entity and at least one of the payor and the surgical provider. Information from the surgical provider is received identifying medical devices actually used in the surgical procedure after the surgical procedure has been performed. Instructions are transmitted to reimburse the surgical provider for costs borne by the surgical provider for medical devices actually used in the surgical procedure. A request is submitted to the payor for reimbursement of the entity for costs borne by the entity for medical devices actually used in the surgical procedure.

In a still further embodiment, a method of facilitating a transaction among a surgical provider, a medical device provider, and a payor, involving medical devices needed for a surgical procedure to be conducted by the surgical provider, includes providing a database that relates surgical procedures and corresponding diagnosis information to one or more medical devices used in each respective past surgical procedure. The database relates the one or more medical devices to respective costs to provide the one or more medical devices to a surgical provider. The database relates the one or more medical devices to reimbursement amounts payable by the payor. At a computer system accessible by a plurality of surgical providers remote from the computer system, data is received from a surgical provider of the plurality of surgical providers that identifies a patient, a surgical procedure to be performed on the patient, diagnosis information relating the patient and corresponding to the procedure, and identification of a surgeon to perform the surgical procedure. At the computer system, the at least one medical device needed for the surgical procedure is estimated based on the surgical procedure data and diagnosis information data received at the receiving step. At the computer system, the at least one medical device identified at the receiving step is related to a respective cost based on the database. At the computer system, the at least one medical device identified at the receiving step is related to a reimbursement amount based on the database. At the computer system and following performance of at least one surgical procedure, information is received from the surgical provider identifying the at least one surgical procedure and at least one medical device actually used in the at least one surgical procedure. At the computer system and in response to the information received from the surgical provider identifying the at least one actually used medical device, a compensation amount is determined corresponding to the actually used medical device. An instruction is generated to compensate the surgical provider based on the compensation amount. From the computer system, a request is submitted to the payor for reimbursement of the entity based on the actually used medical device.

In one or more embodiments of the present system and method, medical devices are identified prior, to reimbursement submission, that should be reimbursed according to a predetermined criteria.

The features, functions, and advantages that have been discussed may be achieved independently in various embodiments of the present invention or may be combined with yet other embodiments, further details of which can be seen with reference to the following description and drawings.

### BRIEF DESCRIPTION OF DRAWINGS

A full and enabling disclosure of the present invention, including the best mode thereof, to one of ordinary skill in the art is set forth more particularly in the remainder of the specification, including reference to the accompanying Figures, by which:

FIGS. 1A and 1B are schematic illustrations of systems for facilitating transactions among a surgical facility, a medical device provider, and a payor in accordance with embodiments of the present invention;

FIG. 2 is a flow chart of a referral process portion of a method for facilitating a transaction among a surgical facility, a medical device provider, and a payor in accordance with an embodiment of the present invention;

FIGS. 3, 4 and 5 are flow chart illustrations of method steps relating to approval by a transaction entity of a transaction among a surgical facility, a medical device provider, and a payor in accordance with an embodiment of the present invention;

FIG. 6 is a flow chart illustration of a fulfillment and logistics portion of a method for facilitating a transaction among a surgical facility, a medical device provider, and a payor in accordance with an embodiment of the present invention;

FIG. 7 is a flow chart illustration of a medical procedure portion of a method for facilitating a transaction among a surgical facility, a medical device provider, and a payor in accordance with an embodiment of the present invention;

FIG. 8 is a flow chart illustration of an order creation portion of a method for facilitating a transaction among a surgical facility, a medical device provider, and a payor in accordance with an embodiment of the present invention;

FIG. 9 is a flow chart illustration of a validation portion of a method for facilitating a transaction among a surgical facility, a medical device provider, and a payor in accordance with an embodiment of the present invention; and

FIG. 10 is a flow chart illustration of a billing portion of a method for facilitating a transaction among a surgical facility, a medical device provider, and a payor in accordance with an embodiment of the present invention.

Repeat use of reference characters in the present specification and drawings is intended to represent same or analogous features or elements of embodiments of the present invention.

### DETAILED DESCRIPTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with certain embodiments of the invention discussed herein, the term “payor,” or other similar term or phrase, encompasses an entity that pays for a given patient's medical services. In the specific embodiments described here the payor may be an insurer (including an entity that performs health care benefits administration on behalf of an insurer, such as a self-insuring entity, and government insurers), the patient, or both, but it should be understood the payor may be another type of entity. An insurer may be referred to as a “health plan.”

In accordance with certain embodiments of the invention, the term “surgical provider” encompasses an entity providing surgical service to a patient. The term may encompass a surgical facility, such as a hospital or non-hospital surgery center (e.g. inpatient hospital, outpatient hospital, or ambulatory surgery center), a surgeon or surgeon practice, or both. Although in the examples discussed herein, the surgical provider is a surgical facility, it should be understood that similar transactions may be conducted with a surgeon or surgeon's practice. It should also be understood that a surgeon's practice may be part of a surgical facility.

In accordance with certain embodiments of the invention discussed herein, the term “surgical facility,” or other similar term or phrase, encompasses an entity that provides at least physical and organizational requirements for a surgery. The physician/surgeon performing the surgery may be, but is not necessarily, employed by the surgical facility, and the surgical facility may provide other support, such as non-surgeon personnel, pharmacy services, and laboratory services. A surgical facility may be a hospital but may also be a non-hospital surgery center.

In accordance with embodiments of the invention, the term “medical device provider,” or other similar term or phrase, encompasses an entity that provides medical devices to a buyer such as a surgical facility, e.g. a device manufacturer or distributor.

In accordance with certain embodiments discussed herein, the term “transaction,” or other similar term or phrase, relates to an event or exchange by which a first entity provides goods or services to a second entity, and, in exchange, the second entity provides payment for the goods or services received. In one embodiment, a transaction refers to an exchange in which one party provides medical devices for a surgical procedure and receives payment for such medical devices.

In accordance with certain embodiments discussed herein, the term “device,” or other similar term or phrase, encompasses mechanical or organic components that may be permanently implanted in the patient's body in a surgical procedure, e.g. titanium screws, biomedical joints, or a heart valve. As should be understood, a permanent implantable device may require replacement at some future point after surgery but is nonetheless considered permanent because it is not implanted for purposes of near-term removal and because it is intended to remain in the patient's body after conclusion of the surgery and the patient's recovery. It should be understood, however, that the term “device” is not limited to implantable devices and may encompass, for example, surgical tools, disposable materials, temporarily implanted devices, and other items utilized in surgical procedures. Further, a “device” may be a collection of implantable devices in a kit appropriate for use in given procedures.

One or more embodiments described in more detail below encompass a method in which a transaction entity facilitates transactions among surgical facilities, medical device providers, and payors to secure for the facilities implantable medical devices for surgical procedures to be conducted by surgeons at the surgical facilities. Prior to a procedure, a surgical facility sends to the transaction entity information that identifies the procedure, the surgeon's identity, and patient diagnosis information for the procedure, which has been provided by the surgeon. If the surgical facility wishes for the transaction entity to order implantable medical devices to be delivered to the surgical facility for the procedure, the surgical facility may also identify such devices. This may potentially be done where the devices comprise human tissue, but the facility can request the transaction agent to supply any or all of the devices it expects for a surgical procedure, at its discretion.

This communication comprises the surgical facility's request that the transaction entity accept the transaction, i.e. that the transaction entity agrees to cover the cost of providing implantable medical devices for a surgical procedure (with certain caveats, e.g. that the devices are actually used and meet the transaction entity's coverage criteria, which the transaction entity may provide to the surgical facility in any manner acceptable to the parties), and associated risks of payor non-payment, in return for receiving payor reimbursement. To assess whether it will accept the transaction, the transaction entity applies the information provided by the surgical facility to a knowledge base. As used herein, knowledge base refers to data stored in a database and rules and relationships applicable to the data so that the knowledge base provides information useful in performing the function described herein. Based on historical data relating to these types of transactions in the knowledge base, the transaction entity predicts what devices may be needed for the surgical procedure. Based on a predetermined cost profile established by agreement between the transaction entity and one or more providers of these types of devices, and/or based on historical data relating to cost of similar devices in the event no provider agreement is in place or can be predicted for a given device, the transaction entity estimates a cost to provide the implantable medical devices in a given transaction. Where the payor is or includes an insurer, the transaction entity may request information from the patient's insurer sufficient to establish what the insurer will likely pay under the patient's policy to cover the devices, and what percentage of costs, if any, will be the patient's responsibility. Accordingly, based on information from the insurer and possibly information about the patient, the transaction entity predicts a reimbursement amount the transaction entity may expect to recover for the implantable medical devices after the surgical procedure occurs.

In one embodiment, the transaction entity also applies the diagnosis information against historical data that relates diagnoses and the use of implantable medical devices to assess whether the present transaction request appears to be an anomaly.

The reimbursement amount may be more or less than the predicted cost of obtaining the implantable devices. Generally, the transaction entity approves a transaction when the predicted cost is less than the reimbursement amount, or if the reimbursement amount exceeds the predicted cost by more than a predetermined margin.

If the transaction entity approves a given transaction, the transaction entity may purchase from a device provider those devices, if any, the surgical facility requested the transaction entity buy by submitting a purchase order for the requested devices from the transaction entity's computer system to a medical device provider, requesting that the device provider ship or drop ship the devices to the surgical facility. Alternatively, the transaction entity may prepare and send purchase orders to the surgical facility, which in turn submits the purchase orders to the device provider to, in turn, bill the transaction entity. For other devices the surgical facility may need, the surgical facility may order the devices from a device provider (to be billed to the surgical facility or, if the device provider has an agreement with the transaction entity, to the transaction entity), or use devices it has on hand. Following the surgical procedure, the surgical facility notifies the transaction entity what and how many medical devices were actually used in the surgical procedure and the cost to the surgical facility for these devices. For instance, the surgical facility may incur costs for the devices when the surgical facility uses devices it already has in inventory, or that it purchases directly from a device provider or from a device provider representative present during the surgery. Accordingly, the transaction entity knows the amount it and the surgical facility have actually paid for devices for the surgical procedure, the amount the transaction entity expects in compensation for such devices, and the devices actually used in the surgery. The transaction entity then compensates the surgical facility for its costs, either by directly compensating the surgical facility for its actual costs or in accordance with agreement between the transaction entity and a payor (which may result in compensation that differs from the surgical facility's actual costs). Thus, at such point, the transaction entity has provided the medical devices to the surgical facility (whether by directly purchasing the devices for shipment to the surgical facility or by compensating the surgical facility for devices the surgical facility physically acquires), and the transaction entity submits a request to the payor (in this example, the insurer and the patient, according to their respective responsibilities) for reimbursement for the devices actually used in the procedure.

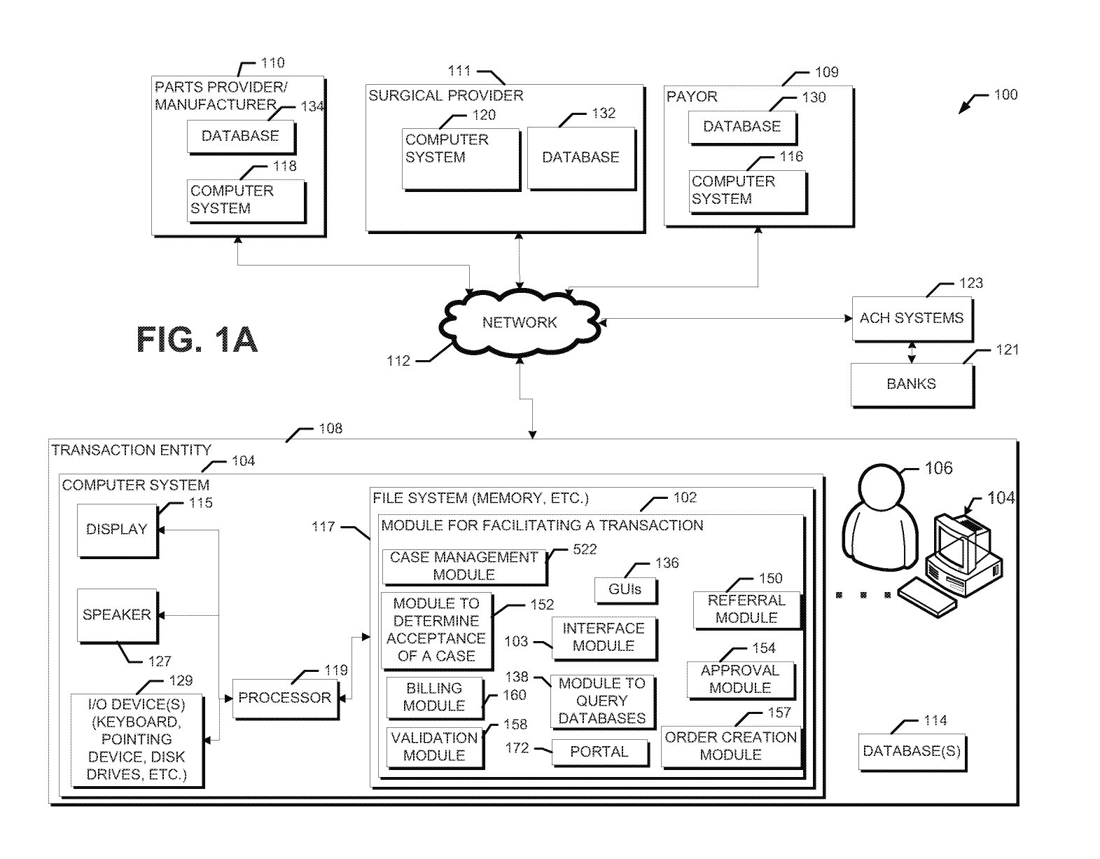

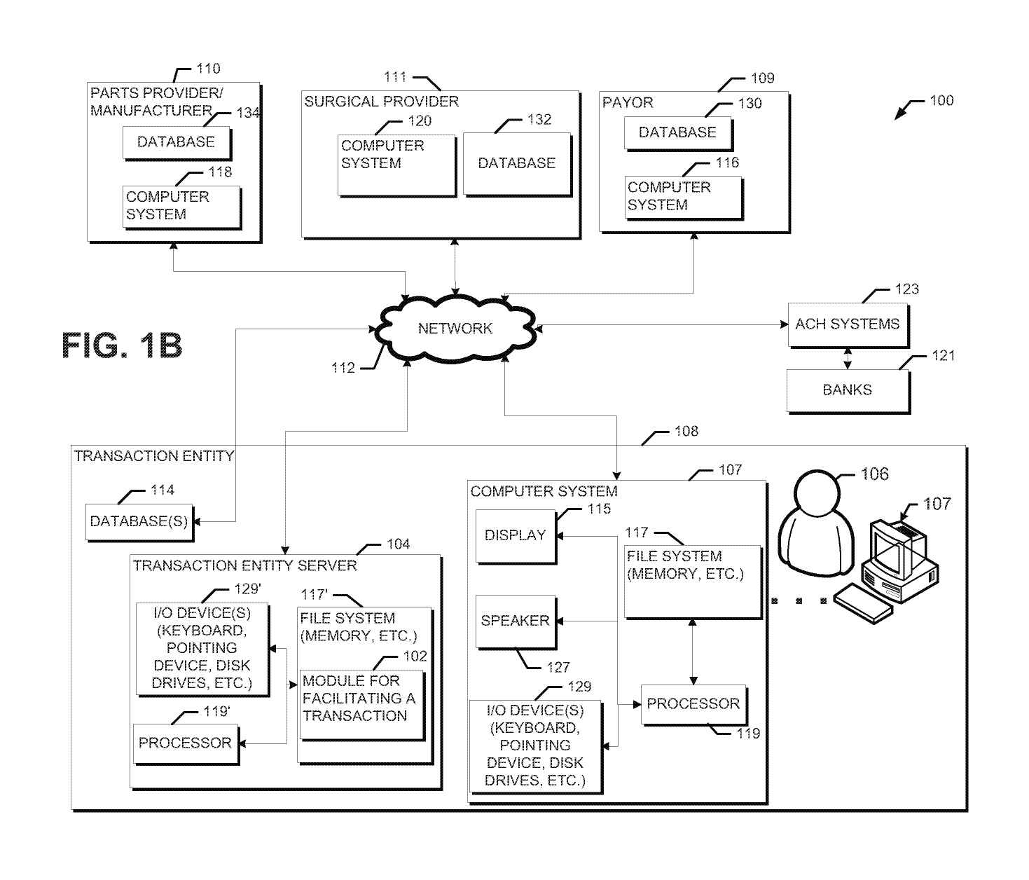

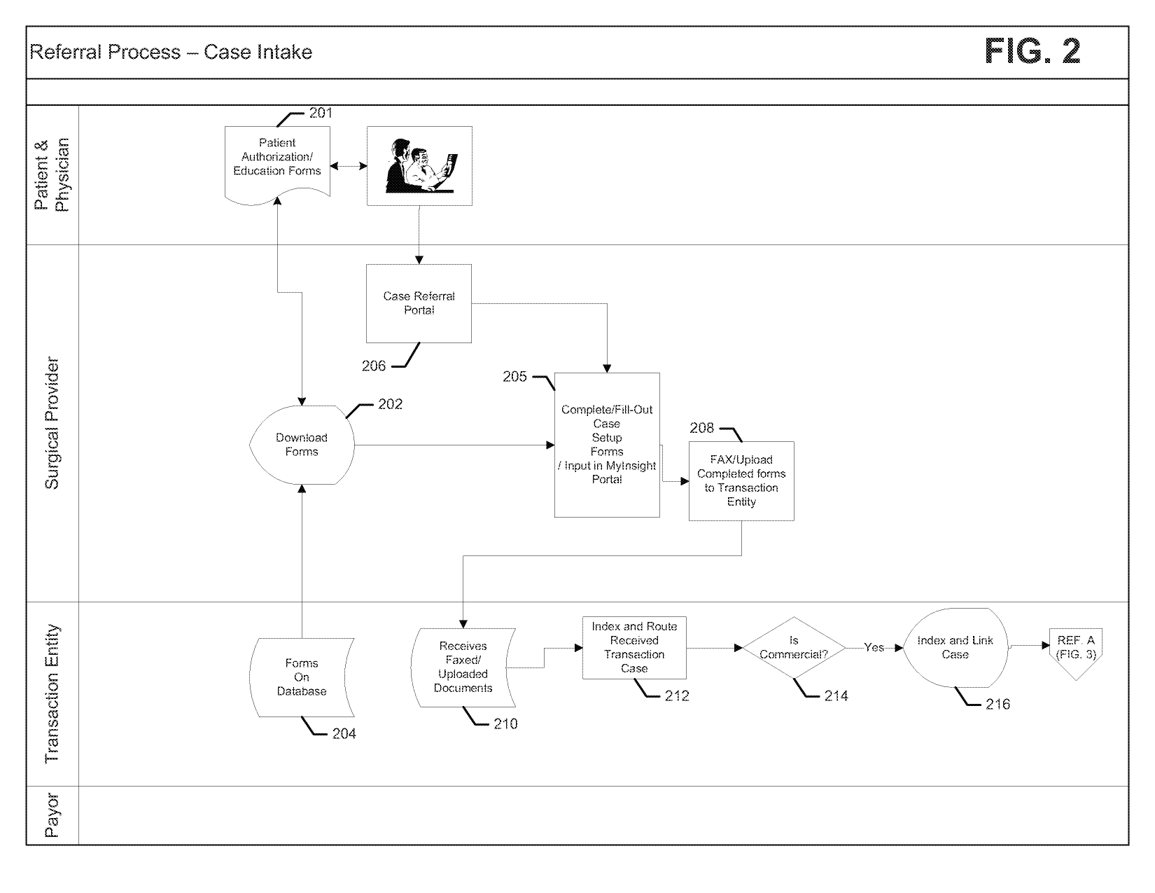

FIG. 1A is a block schematic diagram of a system 100 for facilitating a transaction among a surgical facility 111, a transaction entity 108, a medical device provider 110, and a payor 109 (also including a patient, not shown) in accordance with one or more embodiments of the present invention. Transaction entity 108 resides at the center of and effects the transaction via operation of a module 102 (hereinafter “transaction module”) that in turn resides and operates on a computer system 104. Computer system 104 may be a computer system in the possession of a transaction entity administrator 106, as in FIG. 1A, or may be a server at a locationally remote data center accessed by the transaction entity administrator via a local computer system 107 over a wide area network such as the Internet, as shown in FIG. 1B. Computer system 104 may be a server, a non-server computer system, or may comprise a plurality and/or combination of such computer systems, but is generally a computing device or devices capable of effecting the communications and functions as described herein. Where computer 104 is a server at a local transaction entity facility accessible by computer system 107 over a local area network or a locationally remote data center accessible by computer system 107 over a wide area network such as the Internet, computer system 107 may be a workstation, mobile computer or other suitable means. In general, it should be understood that a single computer system at each entity need not perform all the steps at a given entity as described in the method of FIGS. 2-10.

In the presently-described embodiments, transaction entity 108, payor 109, medical device provider 110, and surgical facility 111 are distinct and remote from each other. The parties are remote, not necessarily in that there is spatial separation among them, but rather that no one party has control over another party's computer systems and data.

Transaction entity 108 maintains a transaction entity database 114 that may be a part of computer system 104 or accessible by the computer system over a local or wide area network. In one embodiment, database 114 and computer system 104 are both located at the locationally remote data center, accessible by administrator 106 and the administrator's local computer system 107 over wide area network 112. Transaction entity database 114 includes a database entry for each payor 109, surgical facility 110 and medical device provider 111. Database 114 has a record for each pending, requested and/or completed transaction handled by the transaction entity, where each record includes data specific to each procedure, such as an identification of each pending procedure, patient demographic data, diagnostic data for each procedure, predicted medical devices for each procedure, predicted costs (to the transaction entity) for each procedure, insurance information for the patient applicable to the procedure, predicted revenue for each procedure, and actual costs and other data as is discussed herein with reference to FIGS. 2-10.

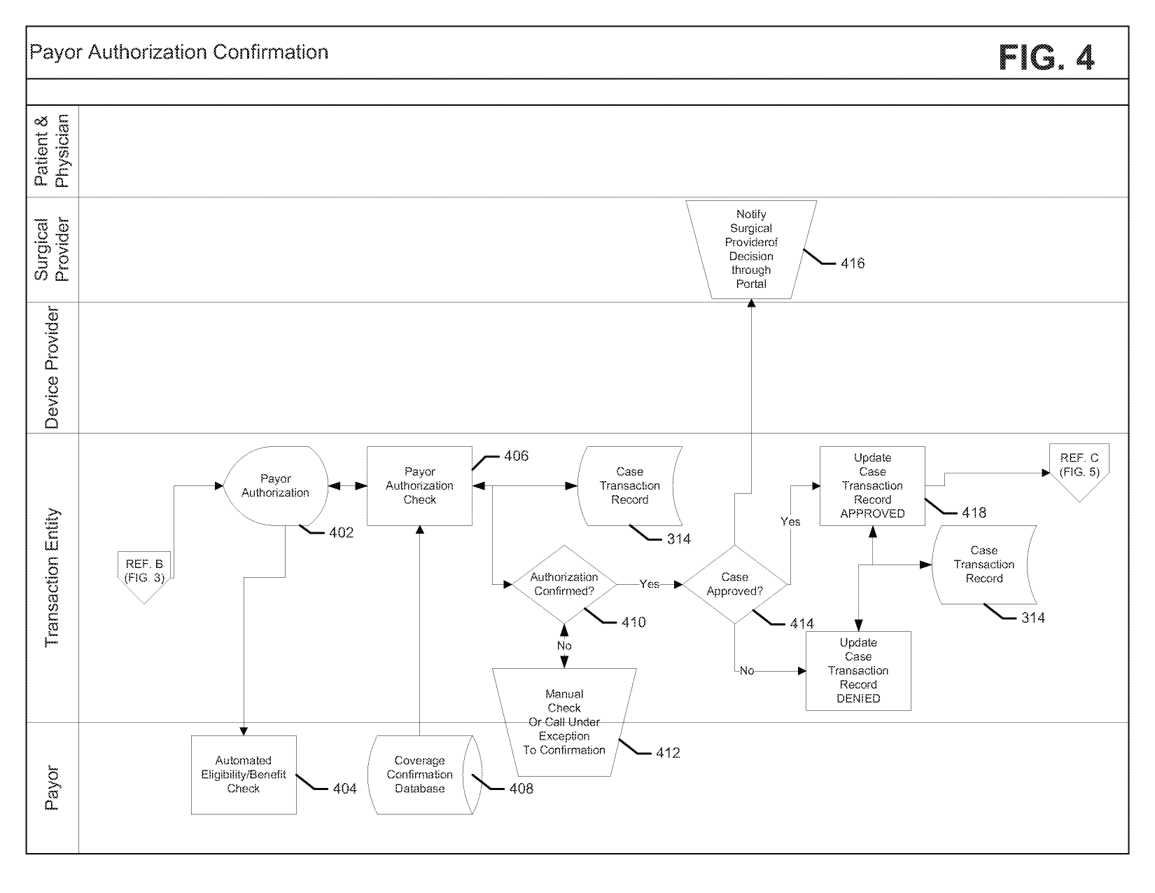

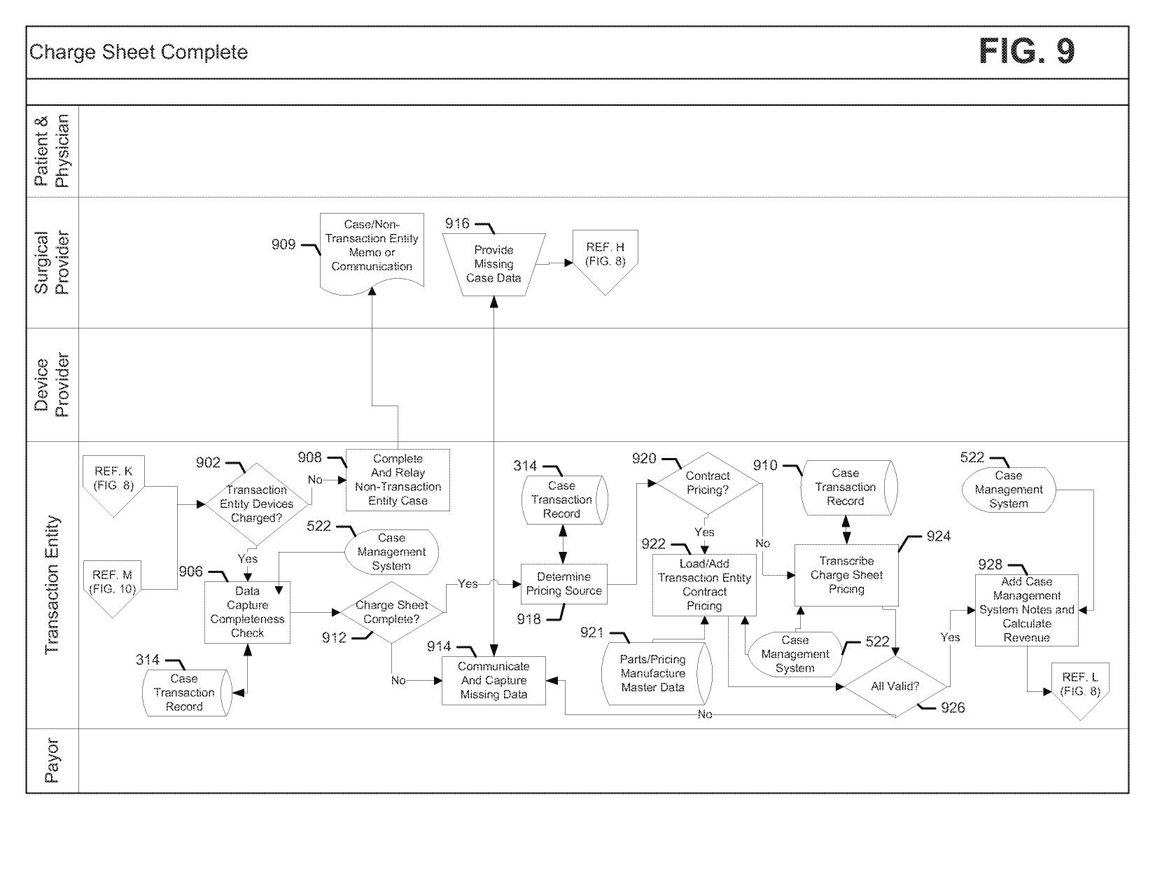

It should be understood that transaction entity database 114 in the Figures may represent one database or multiple databases. For example, transaction entity database 114 may be a database housing data related to each procedure but may also comprise a distinct database relating to insurance information for patients (e.g., a device pricing database discussed with respect to FIG. 9 or insurance coverage data discussed with regard to FIG. 4).

Computer system 104 is also configured to access and communicate with a computer system 116 of payor 109, a computer system 118 of medical device provider 110, and a computer system 120 of surgical facility 111, all via wide area network 112. Network 112 may be the Internet or a private or other wide area network through which computer system 104 may communicate with transaction entity database 114 as well as the computer systems and databases of payor 109, surgical facility 111, medical device provider 110, banks 121, and possibly other computer systems or databases connected to network 112. Network 112 also allows for communications among the computer systems of the entities discussed herein and through automated clearing house (ACH) systems 123 so that payments can be electronically effected, as discussed herein.

It should also be understood that while system 100 is graphically illustrated as connected to a single payor, a single surgical facility and a single device provider, this is for purposes of explanation only, and the system and method described herein may operate with multiple such entities simultaneously. For example, the system may be connected over network 112 simultaneously with a plurality of payors, a plurality of surgical facilities, and/or a plurality of medical device providers, allowing transaction entity 108 to facilitate multiple distinct transactions among multiple different parties at the same time.

One or more of the methods discussed herein is embodied in or performed by transaction module 102. Transaction module 102 may be a self contained software system with embedded logic, decision making, state-based operations and other functions that may operate in conjunction with collaborative applications, such as web browser applications, email, software applications and any other application that can be used to communicate with an intended recipient. In the embodiments of FIGS. 1A and 1B, computer system 104 stores transaction module 102 on a file system or memory 117/117′, accesses the module from the file system and runs the module on a processor 119/119′ associated with computer system 104. Transaction entity administrator(s) 106, payors 109, surgical facilities 111, and/or medical device providers 110 may interact with the self contained system as part of a process of analyzing and processing data related to the transactions.

Transaction module 102 may include various submodules to perform the steps discussed herein, including a submodule 103 that interfaces with the other computer systems to thereby allow the transaction entity and computer system 104 (acting either as the requesting or uploading device) to upload and/or download requested data and other information between computer system 104 and computer systems 116, 118 and 120. Interface module 103 also allows computer system 104 to query and receive requested data from database 114 and distribute the received data to one or more other submodules in transaction module 102, as appropriate, for further processing. A query to submodule 103 may take the form of a command message that presents a command to the appropriate computer system or database, such that module 103 in turn compiles the command and executes the requested function, such as retrieving information from database 114.

Transaction module 102 may also include graphical user interfaces (“GUIs”) 136. Transaction module 102 may present, for instance, one or more predetermined GUIs 136 to permit an administrator at the transaction entity to input/select data into the system, direct computer system 104 to perform various functions, define preferences associated with a query, or input other information and/or settings. GUIs 136 may be predetermined and/or presented in response to attempts by the administrator to perform operations (such as those described below with regard to FIGS. 2-10), execute queries, enter information and/or settings, operate functions of other modules, or communicate with other computer systems. Computer system 104 generates the predetermined GUIs and presents GUIs 136 to the administrator on a display 115 of computer system 104 or, where the administrator interacts with computer system 104 via network 112 using a computing device 107, on a display on the administrator's local computer system as a downloaded page or application. GUIs 136 can be custom-defined and execute in conjunction with other modules and devices on computer system 104, such as I/O devices 129, the interface submodule, or any other submodule. GUIs 136 present notifications to users and may be used whenever a user desires to transmit or retrieve data between computer systems and/or databases, as is discussed herein with regard to FIGS. 2-10. Moreover, users at device providers 110, surgical facilities 111, and payors 109 also interact with the transaction entity and transaction module 102, via GUI's 136, in accordance with the discussion below regarding FIGS. 2-10.

Computer systems 104 or 107 may also include a display 115 and a speaker or speaker system 127. Display 115 may present applications for electronic communications and/or data extraction, uploading, downloading, etc. and may display diagnostic data, procedure data, notifications, etc. as described herein. Speaker 127 may present any voice or other auditory signals or information to administrator 106 in addition to or in lieu of presenting such information on display 115. Computer systems 104 or 107 may also include one or more input devices, output devices or combination input and output device, collectively I/O devices 129/129′. I/O devices 129/129′ may include a keyboard, computer pointing device, or similar means to control operation of applications and interaction features described herein, as well as hand-held scanners for optically scanning documents for storage in database 114. I/O devices 129/129′ may also include disk drives or devices for reading computer-readable storage medium, including computer-readable or computer-operable instructions. Such devices should be understood and are therefore not discussed to further detail herein.

Transaction module 102 also includes a module 138 to query databases (hereinafter “query module”). Query module 138 allows a user to query data from transaction entity database 114 or from other databases 130, 132, 134 via requests to computer systems 116, 120 and 118. Query module 138 communicates with database 114 to upload a query and download requested items via the interface module. After transmission of a query message and retrieval of the query results, query module 138 may store the retrieved data in the memory for future retrieval.

Transaction module 102 further includes a referral module 150, a module to determine acceptance of a case (hereinafter “acceptance determination module”) 152, an approval module 154, an order creation module 157, a validation module 158, and a billing module 160. Each of these modules is discussed below.

Referral module 150 performs the transaction entity's steps of the portion of the method disclosed in FIG. 2. The referral module receives new case referral information from a surgical facility or physician requesting that the transaction entity accept a transaction. As noted above, the referral information preferably identifies the surgical procedure, the surgical facility, the surgery date, the surgeon, diagnoses, and the implantable medical devices the surgical facility requests to be on hand at the procedure.

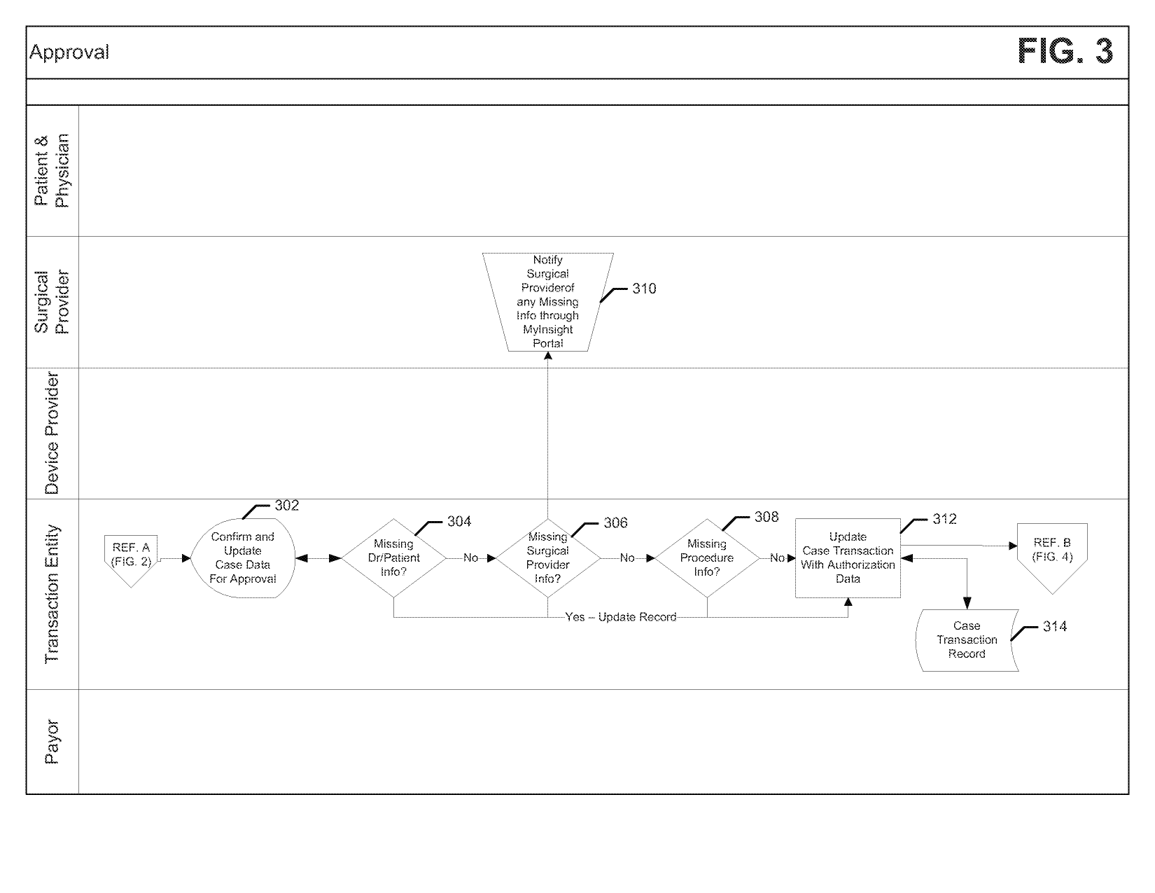

Acceptance determination module 152 performs the transaction entity steps in the portion of the method discussed with regard to FIGS. 3 and 4. Acceptance determination module 152 determines if the referral includes sufficient information for the transaction entity to assess the transaction and, if so, predicts the medical devices that may be used, automatically acquires the patient's health benefit information, estimates the transaction entity's costs and revenue associated with the transaction, and identifies information related to the transaction entity's risk in recovering the revenue. Based on the information, the transaction entity determines whether or not it will accept the transaction.

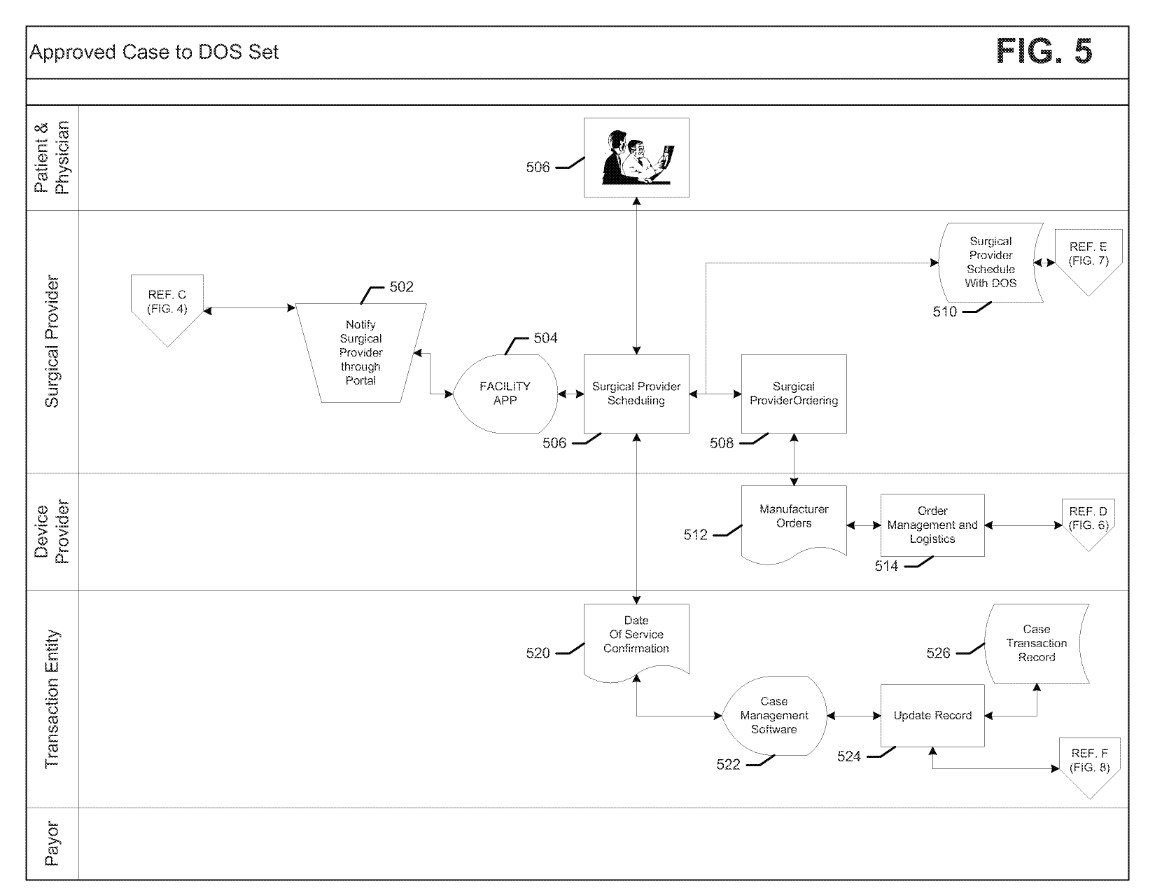

Approval module 154 performs the transaction entity steps in the portion of the method discussed with regard to FIG. 5. Approval module 154 stores surgery schedule information provided by the surgical facility and updates a case transaction record that, as described in more detail below, holds data relating to a particular transaction.

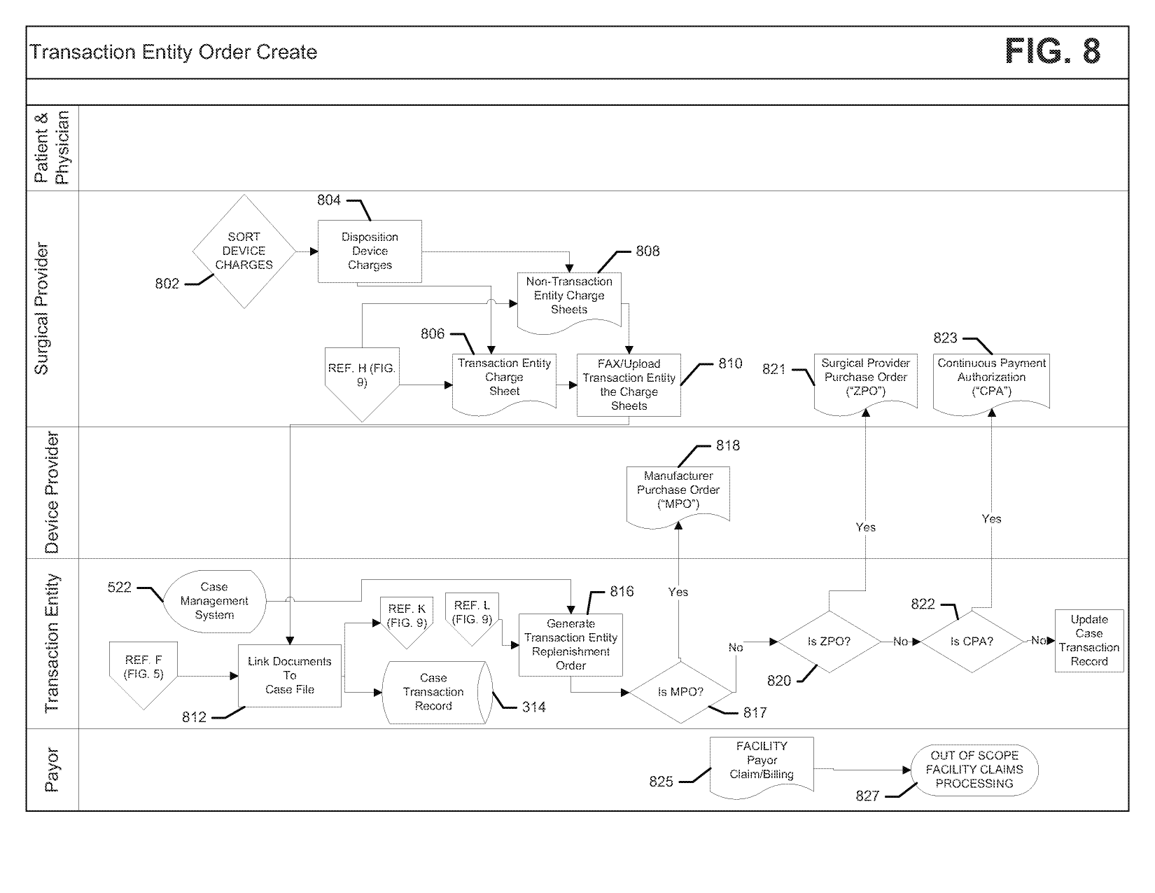

Order creation module 157 performs the transaction entity steps in the portion of the method discussed with regard to FIG. 8. The order creation module receives information from the surgical facility indentifying the implantable medical devices actually used in the surgical procedure and effects steps to compensate the surgical facility for those devices for which the surgical facility paid. As described in more detail below, compensation in the presently-described embodiments may comprise monetary compensation and/or replenishment of devices to the surgical provider's inventory.

Validation module 158 performs the transaction entity steps in the portion of the method discussed with regard to FIG. 9. The validation module confirms whether the medical device information provided by the surgical facility is complete and determines whether there are inconsistencies between the medical devices actually used and the medical devices the transaction entity (based on its knowledge base) expected to be used in the acceptance determination (FIGS. 3 and 4). Validation module 158 also updates the case transaction record with current information. Validation module 158 has need to query a pricing/parts manufacturing database resident at the transaction entity and therefore operates in conjunction with database query module 138 for that purpose. Database 114 may include the pricing/parts manufacturing database.

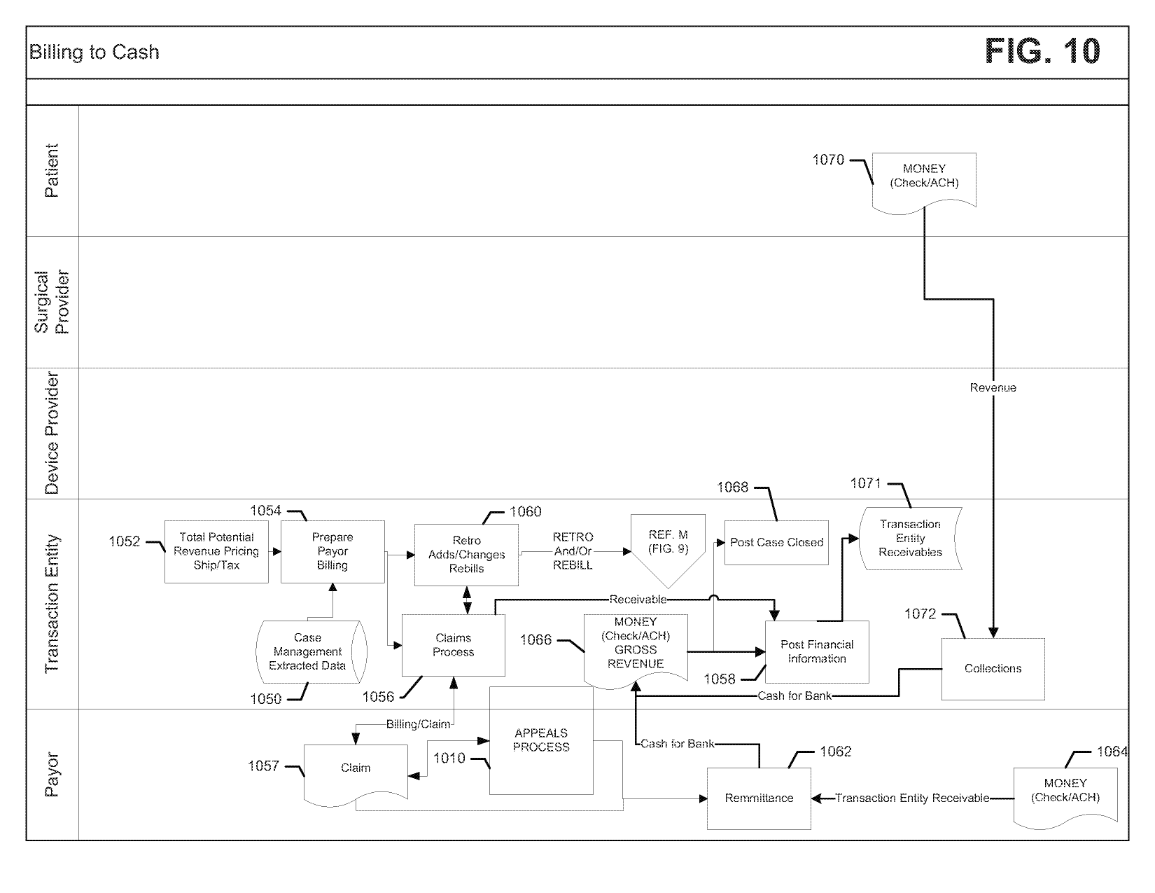

Billing module 160 performs the transaction entity steps in the portion of the method discussed with regard to FIG. 10. The billing module creates and submits claims from the transaction entity to the payor and facilitates the collection of moneys and remittances from the payor, for instance an insurer and/or the patient. Billing module 160 can update the case transaction record to reflect accounts receivable status.

Portal 172 is an application owned/managed by the transaction entity that allows the surgical facility, and/or the physician/surgeon in some embodiments, to directly communicate with the transaction entity over network 112. Portal 172 is a web-based client that can only be accessed if the user has an authorized username and password combination. Portal 172 allows for data, which may be in document form or other format, to be transmitted from the surgical facility to the transaction entity. Additionally, an administrator at the surgical facility can log into portal 172 from outside a local area network on which module 102 resides to view the status of cases, to receive notifications, and to provide any information needed.

FIGS. 2-10, as discussed below, illustrate one or more methods of facilitating a transaction according to various aspects and embodiments of the present disclosure. The flowcharts and block diagrams in the Figures illustrate the architecture, functionality, and operation of possible implementations of systems, methods and computer program products according to various embodiments of the present invention. In this regard, each block in the flowchart or block diagrams may represent the operation of a module, segment, or portion of code, which comprises one or more executable instructions for implementing the specified logical function(s). It should also be noted that, in some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

Additionally, each of FIGS. 2-10 illustrates a table with different rows or “swimlanes.” In each row or swimlane, an entity is identified at the left-hand side, and blocks are illustrated on the right. Each block is performed by the entity (or device associated with an entity) listed at the side of each row according to some embodiments. However, it should be understood that the methods disclosed below should not be limited to such entity (or device associated with the entity) performing such steps. Other entities in other rows or swimlanes could perform such steps in certain circumstances or embodiments. As illustrated, various entities or devices are shown in swimlanes or rows of the Figures, including “Patient & Physician,” “Surgical Facility,” “Transaction Entity,” “Device provider,” and “Payor.” The individual blocks in each of the rows or swimlanes of FIGS. 2-10 are discussed below.

Initially, assume a patient visits a physician/surgeon for diagnosis or to request surgery and that the physician analyzes the patient and determines the patient needs surgery. Assume also that the surgery requires implantable medical devices. These events may trigger a referral, i.e. in the presently-described examples the capture of procedural information that the transaction entity may accept as a request to facilitate a medical device transaction. The transaction, in turn, is the process of acquiring/purchasing implantable medical devices required for a given surgery and settling payment for those devices.

FIG. 2 illustrates the referral process portion of a method for facilitating a transaction among a surgical facility, a medical device provider, and a payor in accordance with an embodiment of the present invention. The referral process includes steps by which the physician/surgeon provides information to the transaction entity so that the transaction entity may determine whether to accept and initiate a given transaction.

At 202, the physician/surgeon, outpatient surgery center, or other user uses a computer system 120 (FIG. 1) at surgical facility 111 (or other location) to download, via interface module 103 activated by a GUI 136 presented by computer system 104 to the surgical provider user's computer, transaction forms from transaction entity database 114 (FIG. 1), as indicated at 204, such as patient authorization forms, privacy forms, patient education forms to provide information to the patient, and the like. Upon downloading the forms from the transaction entity's database 114, the physician/surgeon may provide the forms to the patient electronically or in hardcopy form, as indicated at 201, upon or after the physician/surgeon or other user and patient decide that a surgery should occur.

The surgical provider/swimlane illustrated at FIG. 2 relates to steps taken by a hospital or other surgical facility administrator, having been notified by the physician/surgeon of the need to schedule a surgery and having scheduled the surgery, to then submit associated information to the transaction entity for consideration regarding whether the transaction entity will handle the medical device transaction. The term “case,” as used herein, refers to such a transaction from the transaction entity's perspective. The administrator may submit a case to the transaction entity's system through an electronic interface using surgical facility computer 120 to interact with transaction entity referral module 150 via network 112, portal 172, a GUI 136, and interface module 103, or by downloading (also by network 112, portal 172, GUI 136, and module 150) and printing (via computer 120) forms, and then transmitting the completed hardcopy forms (e.g. by mail, facsimile, or scan/email) to the transaction entity.

If the surgical facility administrator enters the case into the transaction entity's system electronically through case referral portal 172, as indicated at 206, the administrator logs into the portal from surgical facility computer 120 using the surgical facility's username and password and enters relevant case data directly into web-based forms, as indicated at 205. Case referral portal 172, in conjunction with GUI 136 and module 150, allows the surgical facility administrator to directly input (a) patient demographic data, physician/surgeon identification, patient diagnosis information (in terms of International Classification of Diseases, 9^{th} Revision, Clinical Modification or “ICD-9” codes), and surgical procedure information (in terms of Current Procedure Terminology or “CPT” codes) that the surgical facility receives from the physician/surgeon, (b) patient benefit information, insurance information, etc. that the surgical facility may receive from the physician/surgeon or directly from the patient, (c) any medical devices (in this example, implantable medical devices, or permanent implantable medical devices) that the surgical facility and/or surgeon requests the transaction entity to order and be provided for the procedure, and (d) surgery scheduling information that the surgical facility develops itself or in conjunction with the physician/surgeon and/or the patient. The user's login information identifies the surgical facility, allowing module 150 to identify the surgical facility in the case transaction record. While the present disclosure assumes that procedures are always identified by CPT codes, and that ICD-9 codes (whether diagnostic or procedural) are always used for diagnostic purposes and will be accompanied by CPT codes, this should be understood to be for purposes of example only and that other coding or other systems could be used. Moreover, it should be understood that these coding systems are or may be updated over time. For example, it is expected that ICD-9 codes will be replaced by ICD-10 codes. Thus, it should be understood that the particular discussion of CPT and ICD-9 codes herein is provided by way of example and not limitation.

More specifically, the surgical facility administrator accesses (over network 112) and logs into portal 172 by entering the surgical facility's authentication credentials into the portal GUI. Transaction entity computer/server 104 receives and authenticates the surgical facility administrator's login credentials. If authenticated, the administrator can browse portal 172 to access information associated with cases previously submitted by the same surgical facility and also download forms. To enter case referral data into portal 172, the administrator selects an option indicating that the administrator wishes to submit a new case. The administrator then enters the relevant information (as requested by automated forms provided by a GUI 136 via portal 172) to request approval from the transaction entity, as indicated at 205, such as the patient's name, patient insurance and benefit information, surgery information, and other information as noted above needed to set up a new case. When the surgical facility administrator completes the needed information and executes a “save,” “submit,” or similar function through the GUI, computer system 104 then saves the data in database 114 in a new case record, as generally indicated at 205, 208, and 210.

As mentioned above, the surgical facility administrator may alternatively submit a case for approval using printed forms downloaded from the transaction entity's website. The surgical facility's computer 120 sends a request for the forms to the transaction entity computer system 104, which in turn requests relevant forms resident on transaction entity database 114, at 204. The transaction entity computer system retrieves the forms from database 114 and transmits the forms to the surgical facility computer 120 via modules 152 and 103, portal 172, and network 112. It should be understood, however, that the forms filled out need not be from the transaction entity. As such, the transaction entity may accept other types of forms, such as those the surgical facility has developed on its own.

At 205, the surgical facility administrator completes the case setup forms with the data as described above and, at 208, transmits the completed case setup forms to the transaction entity via email, upload, or facsimile. In one embodiment, the administrator uploads a scanned form via an application programming interface available from the transaction entity's site. The API (at 103) captures the scanned form at a print dialog box on the administrator's computer system 120, acquires the form data by an optical character recognition program and populates the data into the case transaction record. The API provides the user the ability to select predetermined document types, e.g. referral, billing, or charge sheet. If the user selects a document type, the API appends corresponding metadata to the document image. At 210, the transaction entity receives the documents from the surgical facility, manually (in the case of faxed or emailed documents) or automatically (in the case of uploaded documents) extracts the case data from the forms, and stores the data as a new transaction record in database 114, at 210. Computer system 104 also stores an electronic image of each form in the database, associated with the corresponding case transaction record.

The transaction entity server creates a new entry in database 114 for each received case, whether received via a faxed or scanned form (and entered into computer system 104 manually) or directly electronically via portal 172, and regardless whether the transaction entity accepts or denies the case. This allows the transaction entity to later query data relating to all initiated transactions.

At 212, the transaction entity indexes and routes the received case. As will be understood in view of the present disclosure, the surgical facility may submit to the transaction entity not just case referrals, but also other types of documents, such as medical necessity reports or invoices in support of medical device charges, and the transaction entity system thus includes a mechanism to differentiate among incoming documents of various types. When a document is received (whether by download, scan, or facsimile/manual entry), a transaction entity administrator accesses computer system 104 directly or using the administrator's computer, selects an option to view newly received documents presented by a GUI 136, examines images of each received document, and determines each document's type. Still using the GUI, the administrator then electronically routes each document to a person at the transaction entity based on the document's type. Alternatively, where a document image has appended metadata identifying the document type, module 150 automatically routes the document to a predetermined recipient according to a table in database 114. For example, if the transaction entity administrator or, if automatic, module 150 identifies the document as a new case referral, the administrator or module 150 electronically sends a copy of the referral document to a case management team. If the administrator or module identifies the document as an invoice, the administrator/module sends the document to a materials management team. While the data in the documents is already stored in the database, the document copies may be used by the teams manually in the performance of their duties, if they choose.

At 214, the transaction entity determines whether or not the new case is associated with a commercial payor or a non-commercial payor. A commercial payor is a payor having an existing agreement with the transaction entity that defines business rules governing reimbursement for medical procedures, such that the transaction entity can refer to those rules in estimating revenue and in submitting claims post-surgery. A non-commercial payor is a payor that does not have an existing agreement with the transaction entity. The system does manage cases with non-commercial payors but may rely more on information about the patient's policy with the payor, and on historical data, in estimating revenue, and on the patient policy information in submitting claims post-surgery (in some instances of a non-commercial payor, the transaction entity may instead have an agreement with the surgical facility that defines such business rules, and in these instances the transaction entity/surgical facility agreement is used instead of the transaction entity/payor agreement as described herein). Typically, commercial payors are insurers, although other types of payors could also be commercial. Insurers may be non-commercial payors, as may be insurer administrators and government insurers. Database 114 maintains payor fields in each case transaction record that identify the payors according to a predetermined list of types and that identify whether each payor is associated with an agreement with the transaction entity and, therefore, commercial or non-commercial. If a case is commercial (or, if non-commercial but there exists a transaction entity/surgical facility agreement), the transaction entity indexes and links the case to its agreement terms at 216. For both commercial and non-commercial cases, the system submits the case for approval as discussed with respect to FIG. 3.

FIG. 3 illustrates a case approval portion of a method for facilitating a transaction among a surgical facility, a medical device provider, and a payor in accordance with an embodiment of the present invention. As previously discussed with regard to FIG. 2, the surgical facility has submitted a referral for a new case to the transaction entity, e.g. by uploading data to the transaction entity's computer system and database using the portal. At 302, acceptance determination module 152 performs an initial check of the case data to see if any of certain predefined conditions exist that require denial of the request. In some embodiments, for example, module 152 automatically denies acceptance of a case based on surgery type, which is one of several information options the case referral portal 172/GUI 136 presents to the surgery facility administrator during data entry. There may be certain surgery types, for instance, for which the transaction entity does not facilitate transactions, and if the surgical facility administrator has selected one of these surgery types in creating the referral, module 152 now informs the administrator, e.g. via portal 172 and GUI 136 or by email, that the case is automatically denied. By way of another example, if the surgical facility administrator's referral data indicates that the payor on a given case is ABC company, and the transaction entity does not have an operative relationship with ABC company, module 152 notifies the administrator of the denial, and of the basis for denial, via the portal and GUI.

Module 152 also checks the case transaction record data to identify whether the recommendation for the surgical procedure or procedures identified in the case is outside an expected relationship between diagnoses and procedures as defined by the knowledge base. As should be understood, there are a finite number of surgical procedures (as represented by CPT codes) that result in the use of implantable medical devices. Based on its experience or through the acquisition and examination of historical data, the transaction entity may first identify those procedures (CPT codes) that can result in implantable medical devices. The transaction entity identifies the CPT codes corresponding to these procedures and inputs them into tables in database 114. As also should be understood, procedures result from diagnoses (accordingly, the case transaction record associates each CPT code in a given transaction with the one or more ICD-9 codes that form the diagnosis basis for the procedure represented by the CPT code). This may cause a given CPT code to appear in the database table multiple times, if the procedure arises from multiple different diagnoses. Thus, for each CPT code instance, the transaction entity enters one or more associated ICD-9 codes, resulting in a plurality of CPT/ICD-9 code combinations that represent all CPT/ICD-9 code combinations recognized by the system that may result in implantable medical devices. Ancillary information may be associated with code combinations, in order to define relationships between given code combinations and other conditions that may affect reimbursement. For example, under a given insurance plan, a given procedure (CPT code) might be reimbursable only if the procedure is performed at a certain type of surgical facility (e.g. a non-hospital surgery center, as opposed to a hospital). The site-of-service requirement will be located in the insurance data described below, but it may also be defined in the tables in association with the relevant CPT/ICD-9 code combinations and insurer identities. This is, however, only an example and is provided to illustrate that the code combinations can be associated in the knowledge base with data that impacts later reimbursement decisions.

In some instances, certain diagnoses may always result in a given procedure, but a surgeon's or physician's decision to prescribe certain other procedures in view of given diagnoses may be more discretionary. Accordingly, the system monitors incoming cases to confirm whether the rate at which a prescribing physician/surgeon prescribes a given procedure is outside a range expected based on historical prescriptions in similar circumstances. The first step in this process is to confirm that the particular CPT/ICD-9 code combination is one supported by the system, which in the presently-described embodiments comprises checking data records of past transactions to confirm if the present code combination has before been the subject of a case. If the combination is not in the historical records, then the referral may include a request for a surgical procedure not supported by the system, and module 152 informs the administrator of the issue, e.g. via portal 172 and GUI 136 or by email. Further, as noted herein, the transaction record is associated with patient insurance information. That information may reflect that the patient's policy will not reimburse for a given procedure. If the referral includes a procedure code, or possibly a procedure/diagnosis code combination that is excluded from coverage under the patient's policy, module 152 also informs the administrator of the issue. The administrator may request further information from the surgical facility and then select an override option in the GUI to allow the case to proceed with the code combination, or may deny the case, or may eliminate the code combination from the case and allow the case to proceed with respect to other, allowed procedures. In the latter instance, the module updates the case transaction record at 314 to remove the disallowed CPT code and its associated ICD-9 codes.

For each CPT/ICD-9 code combination present in the historical records of past transactions in database 114, the module identifies each instance in the existing historical data records of the ICD-9 (diagnosis) codes for that particular combination. Module 152 then determines the percentage of these identified records in which the subject combination's CPT code also resulted from that diagnosis. That is, this percentage represents a percent likelihood, based on the historical data, that the diagnosis will result in prescription of the corresponding surgical procedure. The collection and association of this data in the knowledge base may be considered as a database table and is discussed in this manner for ease of explanation.

The module checks the ICD-9 codes associated with a given CPT code in the transaction record and determines if these codes match the ICD-9 codes identified for an instance of the same CPT code in the table. If so, module 152 then identifies the instances in past records of database 114 having the same surgeon as the present record and having the same ICD-9 codes and determines the percentage of those instances resulting in the CPT code appearing in the ICD-9/CPT code combination of the present case transaction record (it should be understood that these relationships are for purposes of explanation and not limitation—e.g., the relationship could be defined at the HCPCS/DRG code level, rather than the CPT and ICD-9 code combination level). If this percentage is greater than the historical percentage recorded in the database table for this code combination by more than a predetermined variance (for example a standard deviation, average absolute deviation, or manually-selected variance), module 152 informs the administrator, e.g. via portal 172 and GUI 136 or by email, that further information is needed to confirm the case data is correct. The administrator may refer the case back to the surgical facility for an explanation why the procedure is medically necessary. If the surgical facility re-submits the case, along with medical necessity documentation and/or an operative report, module 152 will again flag the anomaly and so notify the transaction entity administrator, but the administrator may then waive the objection based on a report, thereby allowing the case to proceed.

The criteria for assessing automatic denial conditions are within the transaction entity's discretion and can vary as desired.

Also beginning at 302, the transaction entity server verifies that all of the information needed (as determined by the transaction entity's internal criteria) for the transaction entity to approve the case has been received. Module 152 examines the case transaction record's predetermined fields and determines, based on the data present in or absent from the various fields, whether there is any missing physician/patient information (304), missing surgical provider information (306), missing procedure information (308), or other information (e.g., missing name/address, national provider information (as should be understood, an “NPI” number is an identifier provided to health care entities by the Centers for Medicare and Medicaid Services), insurance information such as insurance member ID, insurance group number and/or insurance policy number, facility information, etc.). If any information is missing, the transaction entity server (module 152) so notifies the surgical facility computer 120 through portal 172 and network 112, as indicated at 310. The surgical facility may then log into portal 172 to update the information with additional data, at 312, or the data may be directly uploaded or sent to the transaction entity by facsimile and manually keyed into the system. Module 152 updates the relevant case transaction record in database 114, at 314. The information for the case is now complete in database 114, and the case is thus ready for the transaction entity's review for approval.

FIG. 4 illustrates a payor confirmation portion of a method for facilitating a transaction among a surgical facility, a medical device provider, and a payor in accordance with an embodiment of the present invention. Having set up the case in its system (FIG. 3), the transaction entity, via module 152 at 402, sends certain case data from the transaction entity's case transaction record to the payor, as indicated by the arrow extending from 402 to 404 in FIG. 4. Referring also to FIG. 1, transaction entity administrator 106, in communication with transaction entity computer 104 via a GUI 136 in conjunction with modules 152 and 103, selects the desired case, thereby causing module 152 to retrieve the case data from the case transaction record in database 114 and interface module 103 to submit the case data to payor 109 computer system 116 via communication through network 112. In another embodiment, modules 152 and 103 automatically submit the case to the payor, without need of manual intervention by the administrator.

At 404, payor 109 saves the case data in its database 130 and reviews the case data through its computer system 116. At this point, the payor (in this instance, an insurance company, an insurance administrator, or a government insurer) does not know what procedure is being performed, or any diagnosis information, but can nonetheless initially review the patient and insurance identification data to determine if any threshold barriers exist that would cause the insurer to refuse coverage (i.e. payment) without further review. For example, is the patient identified in the initial case data actually covered by an insurer-underwritten insurance policy? If so, is the patient in good standing? If any of these, or possibly other data-related, questions are answered in the negative, the insurer may notify the transaction entity that a given procedure is not covered by the patient's insurance plan, and/or perhaps that given medical devices are not covered. Alternatively, if all such questions are answered in the affirmative, the insurer may initially approve the case. Still further, the information provided by the transaction entity might not be determinative, such that the insurer raises qualified objections but recommends follow up with the transaction entity, e.g. because pre-authorization information is needed. Having made such determination, payor 109, at its computer system 116, generates a response that accepts the case, raises objections to the case, or raises an objection to the case with a qualification, such as requesting follow up with the transaction entity, and submits the response to transaction entity computer 104 (via network 112 and interface module 103 to module 152), as indicated by the line between 408 and 406 at FIG. 4. As also indicated, and regardless of the substance of the insurer's response, insurer/payor 109 retrieves the patient's insurance policy information from its database 130 and includes such data in the response to the transaction entity, as indicated by the arrow between 408 and 406.

Receipt of the payor's response and data at 406 causes module 152 to (a) activate a notice to administrator 106 through GUI 136 and (b) save the insurance policy information in the appropriate case transaction record in database 114, at 314 (FIG. 3). Having detected notification from module 152 through GUI 136, administrator 106 reviews the payor's response through GUI 136 and computer system 104, at 410. If the payor's response is negative or negative with a qualification at 410, then, at 412, administrator 106 (through computer 104, GUI 136 and modules 152 and 138) retrieves the case record from database 114 and reviews the case diagnosis, surgery, patient, and insurance information. The administrator may also contact the insurer to discuss the basis of the insurer's objection. For example, the payor may make a qualified response because the patient's insurance policy requires pre-authorization for one or more types of medical procedures. Such requirements are included in the received insurance information, and so in these circumstances, module 152 identifies such procedures (CPT codes) and the corresponding pre-authorization requirements (e.g. specific relevant medical reports) from the received insurance information and determines from the case transaction record if such CPT codes are present in the case. If so, or if the insurance policy requires other pre-authorization information that may not be tied to particular procedures, the transaction entity administrator may communicate electronically, orally or otherwise with the surgical facility to request the needed data. The surgical facility may submit the needed information (as at 208-210, FIG. 2), which module 152 then stores in the database at 314 in association with the case transaction record and sends to the payor (402-404). In some instances, for example where a case transaction record indicates the payor is a certain type of payor (e.g. worker's compensation) that always requires certain forms of pre-authorization information in all instances, module 152 may check the transaction record for the existence of such payor at 312 and, if present, obtain the needed pre-authorization data for the surgical facility at 310 so that the module can send the data to the payor initially at 402-404, and thereby possibly avoid a conditional response at 406.

If the result of this exchange is that the insurer will approve the case, then the decision becomes “yes” at 410. If the result at 412 is that the insurer maintains its rejection, then the decision at 410 remains negative, thereby causing the transaction entity to reject the case, at 414. If the decision at 414 is to reject the case, administrator 106 (via computer 104, modules 152 and 103 and network 112) notifies the surgical facility 111 computer system 120, as indicated at 416.

If, at 410, the insurer has initially approved the case, then at 414, administrator 106 activates module 152 to retrieve, or module 152 automatically retrieves, the case data from the relevant case record in database 114 and present information to administrator 106 through GUI 136 that allows the administrator to assess whether the transaction entity will accept the case. The GUI may present the information in the form of a worksheet that presents the data described below, so that the administrator can visually compare the data in deciding whether to accept the case, or the data can be presented in a segmented format on sequential pages, or in a table format. The format of the data presentation is not, in and of itself, a part of the present invention, and it should be understood that the format may vary as desired. In general, module 152 presents to the user four types of information—(a) estimated cost to the transaction entity to provide implantable medical devices for the surgical procedure corresponding to the case, (b) estimated revenue associated with the case, (c) adjustments to cost and revenue (e.g. arising from actual device costs, if and when known), and (d) information relevant to the likelihood the transaction entity will receive the estimated revenue. The development of each type of information is described below.

Before addressing the data in detail, however, it should be noted that the transaction under consideration in the presently-described embodiments is based upon the delivery and payment for implantable medical devices in a surgical procedure. The analysis described below is therefore based upon costs and reimbursement coverage applicable to such devices, rather than costs and reimbursement coverage applicable to other aspects of the procedure, such as surgical facility costs, physician/surgeon costs, laboratory costs, or pharmacy costs. This is for purposes of explanation, however, not limitation, of the present disclosure, and it should be understood that the systems and methods described herein could be used in conjunction with other types of devices, materials, and/or services related to medical procedures.

It should also be understood that, in the presently-described embodiments, certain of the functions described herein are driven by the accumulation of data in the case transaction record as that occurs, not necessarily by the functional flows strictly as shown in FIGS. 2-10. For instance, module 152 in the presently-described examples predicts the implantable medical devices that will be needed in a surgical procedure in response to the entry of diagnosis data (ICD-9 codes), procedure (CPT codes) data, surgeon identity data, surgical facility data, and/or historical data in the case transaction record and database, regardless when data is applied to the case transaction record. In the example described above with regard to FIG. 2, for instance, the surgical facility completes a case set up form at 205 prior to surgery so that, upon the data's submission to the transaction entity, the system creates a case transaction record, populates the diagnosis and procedure data in that record (at 314), predicts needed medical devices, populates the case transaction record with the predicted devices, automatically estimates costs for those predicted devices, and populates case transaction record fields with the estimated cost data, as described in more detail below. As also described below, however, a surgical facility may sometimes submit a case set up form after surgery occurs. Such post-surgery data, just as the data submitted before surgery, includes the information needed to predict devices and, therefore, causes module 152 to predict needed medical devices and estimate costs, even though it is by this time known what medical devices were actually used. The timing of the submission, and the existence of other data, does not affect the generation of predicted medical devices and estimated costs. This maintains system flexibility and allows the acceptance of data in certain instances without dependence on a particular sequence of events.

### Estimated Cost

In the embodiments described herein, the system estimates cost based on a predetermined relationship between the transaction entity and the surgical procedure to which the case is directed. In these examples, the predetermined relationship is comprised of historical data in database 114 that relates past surgical procedures to their associated costs, e.g. as measured on a per-procedure basis or calculated based on costs associated with medical devices actually used in the past procedures.

The determination of estimated cost triggers from the input of information into the case transaction record from the surgical facility's initial request (or if incomplete, also follow up information). As described above, the case referral request includes ICD-9 codes that identify the diagnosis information associated with the surgical procedure(s), CPT codes that identify the procedures to be performed at the surgery, the surgeon's identity, and the surgical facility's identity. Based on historical data associating these factors to the use of implantable medical devices in past transactions, the transaction entity defines relationships among diagnoses, procedures, surgeon identity, surgical facility identity, the types of implantable medical devices to be used in such procedures, and the number of such devices. For example, where an ICD-9 code indicates a broken leg, and the corresponding CPT codes indicate a procedure to pin the broken bone, the historical transaction data in database 114 may indicate that two to three titanium screws are typically needed. Where the CPT codes indicate a tendon is needed, the historical transaction data may indicate that a tendon of a certain length is typically needed. In one embodiment, upon receiving a case transaction record and beginning the cost estimate process, module 152 first attempts to predict needed medical devices for each CPT/ICD-9 code combination in association with the surgeon identity. For example, for each code combination, module 152 searches the historical records of database 114 for all instances of that code combination in past case transaction records having the same surgeon identity as the present case transaction record. Because the historical records associate the medical devices with the code combinations to which they apply, this search results in a subset of historical data that relates procedure/diagnosis combinations and surgeon identity to implantable medical devices (identified by manufacturer product number) and the quantity of such devices used in each instance (In many instances, the quantity of a device will be the count of that device that is to be used, e.g. nine titanium screws, but in other instances implantable medical devices are denominated in terms of amount, e.g. an amount of bone putty or crushed bone, or a dimension, e.g. a certain length of tendon, and thus the term “quantity” should be understood to correspond to the manner in which a given device is denominated, e.g. count, amount, or dimension). If there are a sufficient quantity of instances (for example, ten) to provide a sufficiently reliable data set, module 152 identifies each product (by manufacturer number) in the search result data set and averages the quantity of each product number used per instance in the data set, rounding each average to the nearest integer. This, then, provides the estimated medical device(s) (identified by manufacturer number), and the estimated quantity of each device to be used, for this code combination in the present case transaction record.

Although it should be understood that reliance on the surgeon identity is but one example of a means for predicting medical devices, such approach may be useful based on an assumption that a given surgeon may be more likely to use the same quantity and type of medical devices for a given procedure as the surgeon has used in the past. If, however, there are an insufficient number of instances of the subject code combination in association with the subject surgeon identity in the historical transaction records, module 152 then searches the historical transaction records and locates all instances of the subject code combination where the surgical facility in the historical record matches the surgical facility of the subject case transaction record. If, again, the number of such instances in a search is at or above a threshold number (for example, ten) module 152 determines the medical devices, and the quantity of such medical devices, in the same manner as described above, and this becomes the estimate of devices and the quantity of devices for the subject code combination for the subject case transaction record.

If there are an insufficient number of instances in the historical records relating the subject code combinations to medical devices on records having the same surgical facility as the present case transaction record, module 152 does not predict medical devices for the subject code combination.

Although, in this example, module 152 dynamically determines the predicted medical devices through examination of the historical records upon the occurrence of each code combination for each case transaction record, it should be understood that the system could also determine the medical device(s), and the number of such devices, for each diagnosis code/procedure code/surgeon combination and for each diagnosis code/procedure code/surgical facility combination in the historical records and pre-populate this data in database 114 so that this sequence of steps becomes a look-up function rather than a calculation function. Moreover, it should also be understood that various manners of predicting medical devices for use in surgical procedures may be encompassed by the present invention, as well as modifications to the specific examples provided herein. For example, rather than identifying medical devices and average numbers over all instances of a subject combination in the historical database, in another embodiment the system makes these determinations over only the most recent ten instances of the subject combination. In such an arrangement, the system emphasizes recent examples in predicting immediately future occurrences. Still further, the administrator may manually define a relationship between a given ICD-9/CPT code combination (or HCPCS or DRG code) and an estimated type and quantity of devices by directly defining the relationship in a table in database 114, or such relationship could be defined based on insurance policy requirements.

In some instances, a particular CPT/ICD-9 code combination will also be associated with patient demographic information that is also present in the case transaction record, e.g. gender. For instance, a tubal ligation must always occur on a patient who is female. Accordingly, it is also encompassed by the present disclosure to associate patient demographic data with procedure and diagnosis data in selecting historical instances in predicting medical devices for medical procedures.

Accordingly, at 414, acceptance determination module 152 retrieves each CPT code and each ICD-9 code (and sometimes patient demographic information) corresponding to each CPT code from the case transaction record under examination. As should be understood, surgeons associate ICD-9 codes to CPT codes (i.e. they associate procedures with the diagnoses that lead to the procedures). Thus, the case set-up forms (FIG. 2, 205) associate each CPT code with any underlying ICD-9 codes (and sometimes patient demographic data), and the case transaction record also relates each CPT code in the record to its underlying ICD-9 codes. Module 152 retrieves each CPT/ICD-9 code combination in the record and confirms that each retrieved code combination has a corresponding entry in the database table of all possible code combinations that can result in implantable devices, as described above. If a given code combination is not in the database, the module provides notice to administrator 106 via a GUI 136, and the administrator may notify surgical facility 111 computer system 120 that the case is rejected or that further information is needed about the particular code combination, as indicated at 416. Alternatively, or in addition, module 152 checks the insurance information associated with this record and determines if the insurance policy precludes coverage of the given code combination. If so, the module gives notice to administrator 106 via GUI 136. Alternatively, module 152 may automatically send notice to the surgical facility. In one embodiment, this ends the transaction until the administrator either approves the case to continue with the code combination, or strikes the code combination from the case, but in another the system automatically eliminates the non-present code combinations from the transaction record and otherwise continues with the remaining transaction.

If all code combinations in the case transaction record correspond to code combinations in the table, then if possible, module 152 predicts the implantable devices, and the quantity of each device, according to the procedure described above, and enters each device type/quantity in the case transaction record in association with the code combination.

The module then determines an estimated cost for the transaction entity to provide each predicted medical device in the case transaction record to the surgical facility (for example, and as described herein, by ordering the devices for shipment to the surgical provider, by paying for devices ordered by the surgical provider, by compensating the surgical provider for devices already purchased by the surgical provider, or by otherwise replenishing the surgical provider's inventory of devices). It should be noted that the estimate applies to devices the system predicts will be used, not to the devices that are actually used. The particular means for estimating transaction entity costs can vary, but in the presently-described embodiments, the system first takes advantage of the possibility that the transaction entity may negotiate prices with device providers beforehand to establish the amounts the transaction entity will pay for various medical devices. As noted above, the predicted medical devices are identified in the case transaction record by the product number used by the provider of the device, for example the device manufacturer. If, for a given device, there exists a negotiated price with the provider (in this instance, a device distributor or manufacturer) of a given device, the module accepts the pre-negotiated price as the estimated price. Because pre-negotiated prices may be associated with shipping costs and taxes relating to purchases from a given device provider, such costs may also be included with the device's per unit estimated cost, either in accumulated form or as three distinct cost numbers associated with a given predicted device.

If, however, a medical device has no contract price, then, module 152 determines an estimated cost based on data in database 114, for example contract prices for the same or similar devices, and historical non-contract costs for the same or similar devices. In one embodiment, transaction entity administrator 106 (FIG. 1) manually reviews transaction records for prices paid by the transaction entity for similar devices and for contract prices with device providers for such similar devices, using a browse or search feature provided by a GUI 136. Based on this manual review, the administrator enters an estimated cost (including shipping costs and taxes) for the device into a predetermined field(s) at GUI 136, which in conjunction with module 152 and module 138, stores the estimated cost in the transaction record.

A manual review may be utilized in this embodiment where no common device classification system exists for a given device within the relevant market-that is, where there is no standard system for classifying devices as a given type or another. In another embodiment, however, for example where an industry or market classification system exists or is created for and defined in database 114, each medical device in a case transaction record is associated with a device type identifier according to the classification system. Module 152 determines the classification type for the medical device under consideration, finds the actual transaction entity purchase price or contract price for all devices of the same type in past transaction records (or, in another embodiment, for those transaction records occurring over a predetermined look-back period or over the most recent selectable number of transactions involving that device type), averages the retrieved prices (including shipping costs and taxes), and inserts the average price into the present transaction record as the estimated cost. Module 152 stores the predicted quantity of each device type, and the per-unit estimated cost, in the transaction record in association with the predicted device type.

Where devices may be predicted, the worksheet screen presented by GUI 136 provides a row for each predicted device type. Each row includes the quantity of such items predicted to be needed in the procedure. A field in the row reflects the transaction entity's cost for the devices themselves (i.e. the estimated cost for the device, multiplied by the predicted number of units or other quantity designation, as appropriate). A total estimated cost for the device, in a given row, is the device cost, plus the sum of shipping and taxes associated with the devices. The worksheet totals the row totals and displays a resulting total estimated cost to the transaction entity.

As noted above, it is possible that a case transaction record may have a code combination for which there are insufficient instances in the historical data upon which to base a prediction of medical devices. For such a code combination, module 152 examines the historical data for all past transaction records (or all records over a look-back period of time or a most recent number, e.g. ten) having occurrences of the subject code combination in which the record has a cost associated with the code combination. As noted above, the use of particular implantable medical devices is associated with the procedures in which they are used, and this is also true when actual cost data is entered into the system, after surgery occurs. Since actual costs are associated with medical devices, and medical devices are associated with procedures, the historical records allow association of diagnosis/procedure combinations with actual costs. Thus, module 152 locates the instances of the subject code combination in the past transaction records, identifies the actual costs associated with those combinations, averages the costs, and associates this average cost in the present case transaction record in association with the subject code combination. Alternatively, where procedures are associated with higher-level codes such as HCPCS or DRG codes, the historical records allow association of the higher-level codes with actual cost, and module 152 locates the instances of the higher-level codes associated with the procedures in the referral in past transaction records, identifies the actual costs associated with those codes, averages the costs, and associates the average cost in the present case transaction record with the procedure/diagnosis code combinations that respectively correspond to the higher-level codes. In the worksheet, this cost may be indicated as a cost adjustment that simply adds to the cost the worksheet otherwise calculated by accumulating costs associated with devices for other code combinations in the record.

It should be understood that the above-described cost-estimation methods are for purposes of example and not limitation. For instance, in some instances an agreement between an insurer and the transaction entity, or between the surgical facility and the transaction entity, may require reliance on a pricing schedule established between a surgical facility and one or more medical device providers in reimbursing the surgical facility accordingly for medical devices. If the transaction entity system detects the presence and applicability of such an agreement for a given transaction record, the system uses the prices in the schedule (which is stored in database 114 and associated with the transaction record) for the estimated prices for the predicted medical devices for that transaction record.

### Estimated Revenue

As described above, revenue to the transaction entity is received from the payor, typically a private insurer, insurer administrator or government insurer, and possibly in combination with the patient. While in the embodiments described herein, the payor always includes an entity having an agreement with the patient under which the entity agrees to reimburse the patient for costs associated with medical procedures, it should be understood that this is for purposes of example only and that the present disclosure encompasses other payor arrangements, for example where a patient is the sole payor. Where the payor includes an insurer, the revenue received by the transaction entity may be governed by a pre-established contractual agreement between the transaction entity and the insurer. As discussed above, the case transaction record includes information identifying the insurer. Thus, module 152, upon retrieving the case transaction record, indentifies the insurer and checks database 114 whether such an agreement exists and, if so, for the agreement's terms. The agreement terms may vary but will generally define the amounts at which the insurer will reimburse the transaction entity for claims to recover costs of implantable medical devices, typically on an HCPCS/DRG code or CPT code level. For example, a given contract may include a schedule of HCPCS/DRG codes or CPT codes that relate to implantable medical devices and provide a per-code reimbursement amount for each. Alternatively, the contract terms may be on a “cost+” basis. In the latter event, module 152 utilizes the per device estimated transaction entity cost (if available) described above as the base line reimbursement amount and adds an additional amount or percentage as defined by the insurer contract terms to determine the final reimbursement amount. Where costs are estimated on a code basis, rather than device basis, the “cost+” contract also defines corresponding mark up amounts or percentages applicable to such costs.

As noted, in the “contract” example, the insurer basis reimbursement to the transaction entity upon HCPCS/DRG codes. As should be understood, HCPCS (Health Care Common Procedure Coding System) codes are published by the Centers for Medicare and Medicaid Services and form the basis upon which the Medicare program pays for medical procedures. These codes are commonly used by private insurance and health care providers for similar billing purposes. Diagnosis-related group (DRG) codes also comprise a coding system some health-care providers use in billing and record-keeping. Thus, in practice, many insurers require that claims be submitted in terms of HCPCS codes or DRG codes and that reimbursement to the insured party be made on a per-code basis. The claimant also submits information to support the claims, such as diagnosis (ICD-9) codes, procedure (CPT) codes, invoices and other information, but such data is only for purposes of supporting the insurer's decision to reimburse based on the corresponding HCPCS or DRG code, not to reimburse on a per-device basis. While reimbursement is typically not made on a per-device basis (although this is possible), the reimbursement claims are nonetheless for reimbursement for costs associated with implantable medical device (in the present example, but non-implantable devices, or services, pharmaceuticals, or other items or services, in other examples) in that the HCPCS and DRG codes correspond to the use of implantable medical devices. In the past, it has been believed that surgical facilities can have a tendency to submit HCPCS or DRG codes to insurers for reimbursement based on questionable supporting documentation, thereby requiring investigation by the insurer and raising the possibility of refused claims. To reduce such complications in the present-described embodiments, the transaction entity relates HCPCS and/or DRG codes to those CPT/ICD-9 code combinations in the database table that will support each code. Given that the transaction entity will provide claims within this predetermined framework between HCPCS or DRG billing codes and supporting diagnosis and procedure codes, the insurers can agree to a fee schedule that assumes a lower level of billing complications.

More specifically, there are presently approximately four thousand, eight hundred thirty two HCPCS codes and eight hundred fourteen DRG codes for which implantable medical devices could be used (which may correspond to about 9,190 CPT codes, 14,775 ICD-9 diagnosis codes, and 3,877 ICD-9 procedure codes where implantable medical devices would be used). For each of these HCPCS and DRG codes, and based on its experience and on previous transaction records available from the database, the transaction entity defines each CPT/ICD-9 code combination that would support that particular HCPCS/DRG code. As should be understood, the HCPCS/DRG codes can be relatively broad. For instance, a code may relate to large joint repair, which may encompass a hip replacement, an HCPCS shoulder replacement, or repair surgery to either type of joint. Thus, there may be multiple ICD-9/CPT code combinations that correspond to any given HCPCS/DRG code, and each such code relationship has a distinct entry in database 114. Because the agreement between the transaction entity and the insurer defines a reimbursement amount for each HCPCS code, the table thereby relates each ICD-9/CPT code combination to a reimbursement amount. Thus, upon determining that a case is on an HCPCS/DRG-based contract basis, module 152 finds each ICD-9/CPT code combination in the present case transaction record. If any code combination is not present in the table, this represents a potentially non-reimbursable charge. Through interface module 103 and portal 172, the administrator (or module 152, automatically) notifies the surgical facility 111 of the problem by a message sent to the surgical facility's computer 120, as indicated at 416. In one embodiment, the system may be configured to deny the entire case upon such occurrence. The system may also provide notice at this point if any predicted medical devices correspond to a device in a table identified as out of production, obsolete, or under recall, as described in more detail below. Alternatively, the notification may be that the case will simply exclude any implantable medical devices related to the excluded code combination (or that is out of production, obsolete, or under recall), thereby allowing the remainder of the case transaction record to proceed. If all code combinations are present in the table, or are all otherwise present after exclusion of non-present code combinations, module 152 identifies the HCPCS/DRG codes corresponding to each ICD-9/CPT code combination present in the record, identifies the reimbursement amount associated in the table with each instance of an HCPCS/DRG code for the insurer contract associated with the case transaction record, and inserts the reimbursement information into the case transaction record.

As noted above, module 152 may estimate costs on a per-device basis. Where revenue is determined on an HCPCS/DRG or CPT-based contract basis, however, revenue associated with a given procedure or procedures is on a per-code, not per-device, basis (although, as noted above, the revenue is for the use of the devices, in that the HCPCS/DRG codes are associated with the use of implantable medical devices in surgical procedures), and the worksheet includes this revenue in the total amounts but not at a per-device level. As noted above, where the insurer contract is on a “cost+” basis, the estimated per-device or per-procedure revenue is the corresponding per-device or per-procedure estimated cost, plus a mark-up as defined in the agreement, for example 15%. Where there is no pre-established agreement with the insurer, the module may treat the case on a “cost+” basis, estimating revenue based on estimated cost plus a predefined mark-up, e.g. 15%. Alternatively, a “cost+” module may relate code combinations to HCPCS/DRG codes as described above, using the average HCPCS/DRG contract price as the estimated revenue.

In any event, module 152 stores a corresponding reimbursement amount in the case transaction record in association with each device (if “cost+” and therefore per-device revenue), CPT code (if CPT-based contract), or groups of one or more CPT codes (if HCPCS/DRG-based contract) in the record. Where revenue is estimated on a per-device basis, the worksheet presents to the transaction entity administrator, in each row corresponding to a medical device in the transaction record, the estimated per-unit reimbursement amount. Multiplying that amount by the number of units (or other quantity designation, as appropriate) for that device in the record, module 152 also displays in the worksheet the total reimbursement amount for that device for that record. The module sums this total for all device types in the record to generate an estimated revenue amount for the record as a whole. Where revenue is based on HCPCS/DRG or CPT codes, the revenues appear only in the total revenue number in the worksheet.

Having determined the total estimated cost and the total estimated revenue for the case transaction record, module 152 calculates the estimated gross profit, i.e. the difference between these two numbers, and populates a corresponding field in the record. This number is also reflected to the administrator on the worksheet. The module also displays on the worksheet the profit margin, i.e. the estimated gross profit divided by the estimated revenue.

### Adjustments to Cost and Revenue

It is possible that there may be costs associated with the case that are not reflected in the case transaction record. Module 152 accordingly provides a text box in the worksheet through which the administrator may enter a monetary amount adjustment to revenue. If entered, this amount is stored in the case transaction record and automatically lowers the case total estimated revenue by the entered amount. The module also provides a text block or pull-down selection to enter an explanation for the adjustment.

The module may also adjust estimated costs to account for actual costs as they occur. The transaction record includes, for each device in the transaction record, an invoice amount for the actual price the transaction entity pays for a device (e.g. if the transaction entity pays for the device directly because the surgical facility includes such a request in a referral, or if it compensates the surgical facility for a device, as described below). Fields are also provided for tax and shipping costs, indicating the actual taxes and shipping costs for the given type of device. Where a referral is submitted prior to surgery, when there are no actual costs, these fields remain blank. However, as the transaction entity purchases devices (whether directly from device providers or as monetary compensation to the surgical facility, as described below), and thereby incurs these costs, the transaction entity administrator manually enters (after reconciling corresponding invoice data to the transaction record) the corresponding cost data into the fields in the case transaction record, and module 152 populates corresponding fields in the respective rows for the applicable devices in the worksheet. Accordingly, each row, corresponding to a given device type, has a total estimated cost and, when the cost for this device are actually incurred, an actual cost. The difference between these numbers for each row sums to a total number that reflects the difference between the estimated cost and the actual cost. Accordingly, module 152 presents this total difference number, or adjusted cost number, to the administrator on the worksheet, and provides an adjusted gross profit number equal to the estimated gross profit minus the adjusted cost number. The difference between the adjusted gross profit and the estimated gross profit, i.e. the adjusted cost, is also identified as a variance in profit.

### Ancillary Considerations

The administrator may consider expected profit in assessing a case, as well as other considerations, for example the amount of that profit that is expected to be paid by an insurer, as opposed to a patient. In that regard, it should be understood that a patient's insurance plan generally allocates a predetermined percentage of medical costs to the insurance carrier and the patient. Since a given transaction record includes insurance information, as discussed above, the record includes these relative percentages, which are also reflected in the worksheet for the administrator's review. A typical split, for example, might be 80%-20% between the insurance carrier and the patient. Module 152 applies this distribution to the total estimated reimbursement amount, so that the worksheet reflects the dollar amount expected to be received from the insurer and the dollar amount expected to be received from the patient, on a per-device basis and total. The use of ancillary data in the acceptance process is not required, however, and its availability for consideration in this process may be allowed or prohibited by agreement between the transaction entity and a given insurer.

The insurance information also carries information that may impact the likelihood that the patient will pay its share of the reimbursement amount. For instance, the insurance information may indicate whether the patient's insurance contract carries a deductible and, if so, the degree to which the patient has contributed to or met the deductible. This information may be presented to the administrator on the worksheet. Because recovery from an individual patient carries a higher risk to the transaction entity than does recovery from the insurer, a lower applicable deductible is generally favorable to the transaction entity.

The insurance policy may carry a lifetime maximum cap, indicating that the insurer will not reimburse for expenses if total lifetime payments to this patient exceed the cap. The existence of the cap, its amount and the degree to which reimbursements related to the patient have contributed to the cap, are part of the case transaction record and are reflected in the worksheet. For instance, where a patient's total lifetime reimbursements exceed or are near the cap, the risk that revenue recovery will shift to the patient's responsibility increases.

Still further, insurance policies often include out-of-pocket maximum levels, so that once the insured's out-of-pocket expense reach that level, the insured will be subject to no further out-of-pocket expenses. If a patient has not yet reached the maximum defined in the patient's policy, the patient may therefore be subject to some degree of payment for the particular case. The out-of-pocket maximum amount, and the degree to which the patient has contributed to that amount, are reflected on the worksheet.

Accordingly, administrator 106 makes a decision whether to accept or reject a case based on the information provided in the revenue worksheet, and for example in particular based on the estimated gross profit, the adjusted gross profit (if available), and the profit margin. In certain embodiments, the transaction entity may establish a threshold estimated profit, possibly in combination with a threshold profit margin, in order to accept a case. The administrator may (or might not) also consider other factors, however, reflected in the data, such as the percentage of the revenue to be recovered from the patient. The transaction entity may assume that the risk of failure to recover revenue from the patient is high. Thus, if the patient's contribution to revenue is a significant part of the profit, the transaction entity may refuse the case even if the case appears otherwise profitable. In the presently-described embodiment, however, the accept/reject decision is the subjective decision of administrator 106, based on the information provided in the worksheet by module 152.

As noted above, if the administrator's decision at 414 (FIG. 4) is to reject the case, administrator 106 (via computer system 104, GUI 136, modules 152 and 103, and network 112) notifies surgical facility 111 by a message to the surgical facility via portal 172, as indicated at 416, and updates the transaction record to indicate the denial, at 314, and the transaction ends. If, however, the administrator determines at 414 to approve the case, the administrator (via computer 104, GUI 136 and modules 152 and 138) updates the case record in database 114 to include an indication that the case has been approved, at 314. Through interface module 103 and portal 172, the administrator notifies surgical facility 111 of the approval by a message sent to the surgical facility's computer 120, as indicated at 416.

FIG. 5 illustrates exemplary processes following case approval in accordance with an embodiment of the present invention, after the surgical facility receives a notification from the transaction entity that the case has been approved at 502, as previously discussed.

At 506, the surgical facility schedules the surgery with the patient using facility application software 504. Referring also to FIG. 1, facility application software 504 resides at the surgical facility's computer system 120 and communicates data and forms to and from the transaction entity's case management system as embodied by module 102. Once the surgical facility administrator schedules the surgery, the administrator actuates software 504 through a user interface at computer system 120 to send a confirmation of the date of surgery to the transaction entity's case management system (via network 112, interface module 103 and query databases module 138), at 520, so that the transaction entity knows when the surgery will take place. The transaction entity's case management module 522 (which should be understood to generally refer to the modules of transaction module 102) updates the case transaction record in database 114 (FIGS. 1) at 524 and 526. The surgical facility may later provide information to the system updating the surgery date, e.g. if the patient did not follow procedures required prior to surgery, or if the patient or surgeon is ill or otherwise unavailable on the originally scheduled date.

At 508, the surgical facility may prepare purchase orders for the implantable medical devices it needs for the surgery. As described below, the transaction entity may send purchase orders directly to the device provider if so requested by the surgical facility, so that the provider ships the devices to the surgical facility and bills the transaction entity, or the transaction entity may send completed purchase orders to the surgical facility, which then sends the orders to the device providers, or the surgical facility may use its own forms to order the devices. Where the surgical facility sends the purchase orders, the device provider may bill the surgical facility (causing the transaction entity to later compensate the surgical facility, as discussed below), or the provider may bill the transaction entity if the device provider and the transaction entity have a pre-existing agreement that accommodates billing under such circumstances. In any event (unless the surgical facility uses its in-stock inventory of implantable devices for all the devices in a given surgery), the device provider may have (at 512) purchase orders for some or all of the implantable medical devices the surgical facility needs for the surgery.

Note that where, as described above, the surgical facility request/referral explicitly lists certain medical devices, the transaction entity orders and pays for such devices directly.

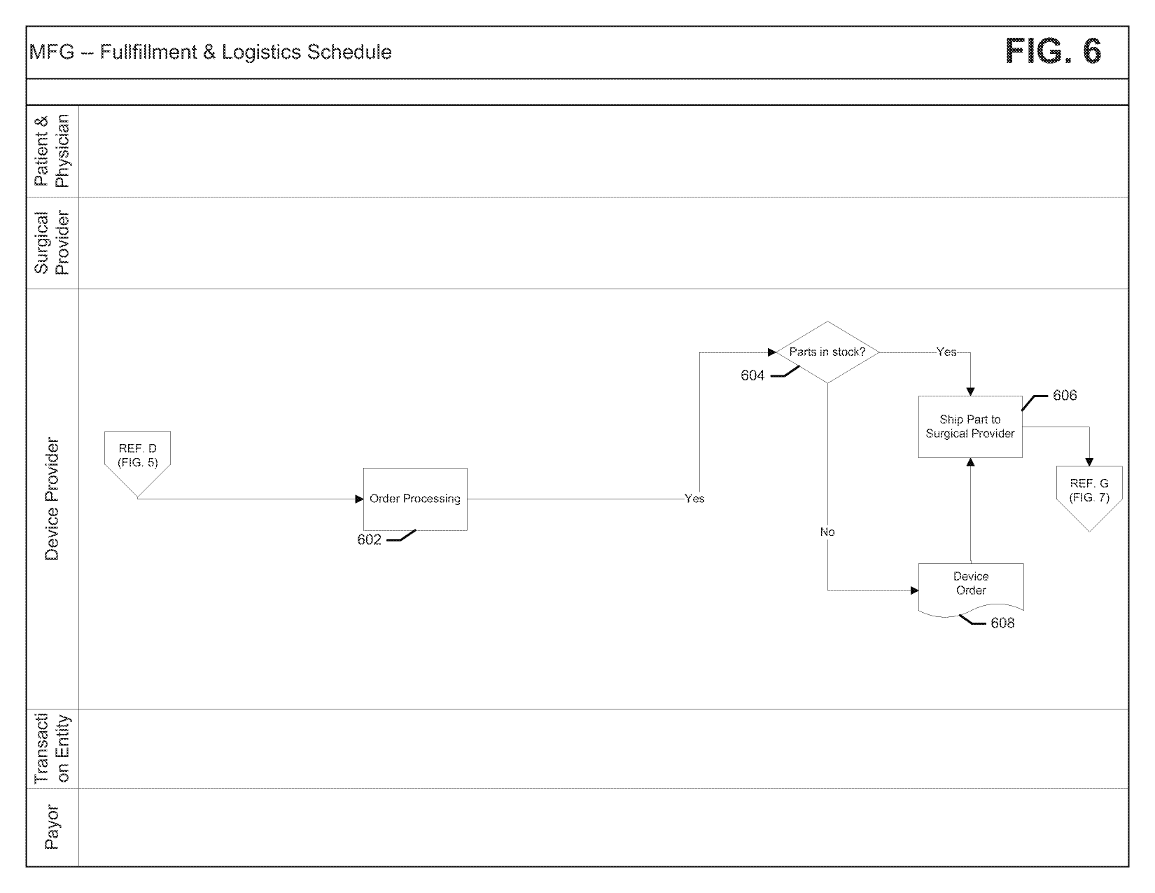

FIG. 6 expands step 514 (FIG. 5), illustrating a fulfillment and logistics portion of a method for facilitating the transaction in accordance with an embodiment of the present invention. At 602, the device provider processes one or more purchase orders (512) received from the surgical facility or the transaction entity. Based on the purchase order and possibly an agreement between the device provider and the transaction entity, the device provider determines its pricing for the devices and the party to be billed. If the device provider decides to accept the order (which it must do, unless the order is facially incorrect), it sends an invoice(s) to the billable party through its electronic data interchange (EDI) system and configures a transaction record in its computer system 118 and database 134. At 604, the device provider determines whether the devices requested on the order are in stock. If so, the device provider retrieves the devices from stock and ships the devices to the surgical facility, at 606.

If the requested devices are not in stock, the device provider can order the devices or can manufacture the devices, as indicated at 608. After the requested devices have been retrieved, manufactured, or otherwise acquired, the device provider ships the devices (or has them shipped) to the surgical facility, at 606, prior to the surgery date indicated on the purchase order.

Regardless whether the device provider provides implantable devices to the surgical facility in the procedure illustrated in FIG. 6, the device provider may send a representative to the surgical facility to be present during the surgery and provide devices directly to the surgical team upon request.

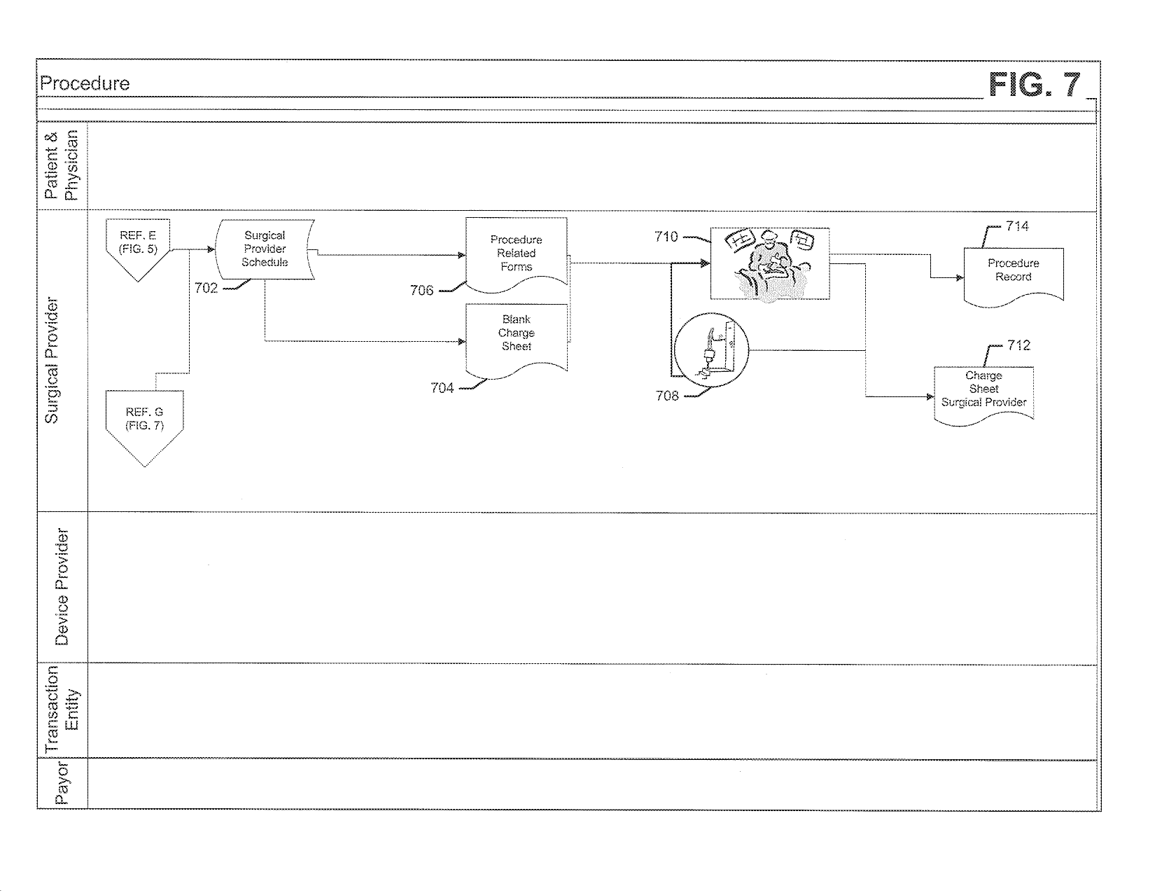

FIG. 7 illustrates a medical procedure portion of a method for facilitating the transaction according to an embodiment of the present invention. At 702, the surgical facility has received the devices (or, as noted above, has them already on hand in inventory), and the surgical facility administrator updates the procedure schedule accordingly. The schedule in one embodiment is an electronic database record that sets times at which various steps associated with the surgical procedure occur and in association with which documents relating to the procedure (including, e.g. a list of needed medical devices, their availability, and their cost) are stored. For instance, at 706 and 704, computer system 120 receives from case management system 522, via module 103, portal 172, and network 112, a series of procedure-related forms and blank charge sheets for use by the surgical facility. The procedure form links the surgical procedure to the corresponding patient, and during or after the surgery (indicated at 710), the surgeon or other members of the surgical team enters into this document (preferably, but not necessarily, electronically via a computer) the actual procedures that were performed (noting the CPT procedure codes and the international classification of disease “ICD-9” codes, updating information in the system as marked). On the charge sheets, the surgical team and/or others at the surgical facility enter information that details the medical devices actually used in the surgery, as well as the patient's identity, any charges incurred by the surgical facility (e.g. because a device was obtained from the surgical facility's inventory and is therefore associated with an acquisition or replacement cost, or was ordered by and paid for directly by the surgical facility, or was purchased from an on-site product representative at the surgery), the procedure performed, the physician/surgeon who performed the procedure, the case number of the procedure, and any other information associated with the devices used. Medical devices can be indicated on the charge sheets in various ways, e.g. handwritten notes indicating the part number, manufacturer identity, and quantity of parts used, or even simply a barcode label removed from the device or its packaging and affixed to the charge sheet. By filling out a blank charge sheet 704 for a given procedure, the physician/surgeon indicates what devices were actually used during surgery, which in turn allows the transaction facility to complete the transaction, as described below.

As noted above and indicated at 708, a device provider representative may be present during the surgical procedure at 710 in the event the surgical team needs medical devices beyond those the surgical facility may have initially anticipated. When the representative provides such additional device, the surgical team and/or the device provider representative describes the device and its cost on the surgery's charge sheet as it would for any other device used in the procedure. Thus, charge sheet 704 documents all actually-used devices involved in the surgery. In one arrangement, the device representative retrieves any devices (from the same provider) previously shipped to the surgical facility for the procedure but not actually used (or, alternatively, the surgical facility ships the unused devices back to the provider), and the device provider later credits the transaction entity for such returned devices.

At 710, the physician/surgeon and others on the surgical team perform the surgery on the patient at the surgical facility using the devices ordered and/or additional devices acquired from an on-hand representative. During surgery, a circulating nurse or other surgical facility staff member captures case/procedure details for the services, facilities, physicians, materials, devices/parts, etc. The staff member then hands off the file as the patient works through the facility to discharge. An assistant reads or otherwise obtains the information on the charge sheet (whether electronically entered or in handwritten or barcode form) and the procedure form, and enters the charge sheet and procedure form data into the surgical facility's database 132 via computer system 120, at 712 and 714. As indicated by the line between 708 and 712, charge sheet data may be provided by the device representative.

FIGS. 8 and 9 illustrate validation and surgical facility compensation portions of a method for facilitating a transaction among a surgical facility, a medical device provider, and a payor in accordance with an embodiment of the present invention. The Figures illustrate a process by which, after a surgical procedure occurs and regardless how medical devices are acquired and paid for, the transaction entity validates use of the devices in the procedure. That is, in the embodiments described herein, the transaction entity confirms that the medical devices used by the surgical facility in a surgical procedure are valid (in these examples, meaning that they are properly reimbursable according to a predetermined criteria). This provides an insurer greater confidence in establishing agreements with the transaction entity for providing reimbursements for medical devices. As noted above, in certain instances the surgical facility, rather than the transaction entity, directly pays the device provider for the devices. In those instances, the procedure described below reimburses the surgical facility, either monetarily or by replenishing devices into the surgical facility's inventory.

As noted above, the surgery's procedure record identifies procedures performed in the surgery, including diagnoses made in the surgery, each procedure and diagnosis having a corresponding code. Each surgical procedure results in a list of CPT and ICD-9 codes corresponding to the particular procedures performed during the overall surgical procedure and diagnoses made prior to or during the surgical procedure. The charge sheet record identifies the actually-used medical devices by lot number, serial number, and manufacturer, and quantity used. At 802, a surgical facility administrator, operating through surgical facility computer system 120 (FIG. 1), reviews the surgery's charge sheet record (FIG. 7, 712) and selects those devices that correspond to the case being managed by the transaction entity. In the presently-described embodiment, these are the permanently implantable medical devices used in the surgery, but it should be understood that the case may encompass non-permanently implantable medical devices, non-implantable medical devices used on a per-procedure (e.g. disposable) basis, and any other device for which compensation will be sought from a payor. This results in a list of devices at 804 that are the subject of the case (e.g. these may be medical devices that are reimbursable under a predetermined set of HCPCS and/or DRG codes that correspond to the use of implantable medical devices), for which the transaction entity either has already paid or will compensate the surgical facility, and for which the transaction entity may seek compensation from the payor.

As noted above, the transaction entity may provide pre-formatted charge sheets that include input spaces for lot/serial/manufacturer number information corresponding to each implantable medical device used in the surgery and for other information needed by the transaction entity to assess the acceptance and pricing for each device, as discussed in more detail below. In one embodiment, this information includes, but is not limited to, the device's lot and serial numbers and/or manufacturer number, the supplier of the device, an indication whether reimbursement is by replenishment or payment (discussed below), the quantity used, and the amount charged to the surgical facility for the device (left blank for devices paid for directly by the transaction entity but otherwise the amount paid by the surgical facility to a device provider for a device the surgical facility directly orders or already has in inventory). It is possible that the surgical facility prefers to use its own charge sheets, and FIG. 8 therefore indicates at 806 and 808 that the surgical facility administrator may input the information relating to the medical devices selected at 804 into either type of form. Regardless of source, these forms may be maintained electronically in database 132, such that the surgical facility administrator electronically completes the forms at computer system 120 for the devices selected at 802 and 804, or the administrator may manually complete the forms. At 810, the administrator prints the charge sheets (if electronic) and submits the charge sheets to the transaction entity, for example by facsimile, e-mail (after the sheets are scanned and attached to the e-mail), or by uploading the sheets to computer system 104 and portal 172. Alternatively, the surgical facility may simply use the same forms completed from the surgical procedure, discussed above with respect to FIG. 7, without creating new forms, and submit the already-existing forms by similar means.

If uploaded through the portal, system 102 notifies transaction entity administrator 106 of the received charge sheet via GUI 136. If by e-mail, administrator 106 opens the e-mail, thereby obtaining control of the attached image or word processing file. If by fax, the administrator acquires the faxed image by an e-mail forwarding system or by scanning the fax into computer 104, depending on the particular configuration of the administrator's computer system. In any event, the administrator stores the submitted charge sheet to database 114 via system 102 using functionality provided through GUI 136. As part of this process, the administrator, via order creation module 157, query databases module 138, and GUI 136, saves the charge sheet document in a manner so that it is linked in database 114 to the transaction entity's existing case transaction record for the surgery identified in the charge sheet, as indicated at 812. If the charge sheet is faxed or e-mailed, the transaction entity administrator may manually enter the data from the charge sheet into the case transaction record, but if the electronic record is uploaded through the portal, order creation module 157 pulls the data from the pre-formatted form. If the transaction entity database has a corresponding case transaction record, modules 157 and 138 automatically save the recovered data into the case transaction record in data fields corresponding to the fields in the form, as indicated at 314. Where the surgical facility uses the transaction entity's pre-printed form, the transaction entity will have earlier entered the case transaction record's unique case number into the form at its creation (after having identified the relevant case based, e.g., on the patient identity and surgery data provided by the surgical facility), so that the transaction entity system can now associate the charge sheet with the correct transaction record. Otherwise, if the surgical center uses its own charge sheet, the transaction entity administrator manually identifies the existence of a corresponding case transaction record by associating the surgery date and the patient with a case transaction record in database 114.

Referring now to FIG. 1 and also to FIG. 9, administrator 106 executes a validation portion of the presently described methods executed in conjunction with computer system 104, GUI 136 and validation module 158. Step 902, and others in the “Transaction Entity” line in FIG. 9, embody steps occurring within step 812 in FIG. 8, and FIG. 9 generally spans FIG. 8 steps 812 to 816. In that regard, when computer system 104 receives the charge sheet for a surgical procedure from the surgical facility from step 810, at 902 administrator 106 activates module 158 (or, alternatively, module 158 activates automatically upon receipt of data) to analyze the data the administrator acquires from the charge sheet at 812. At 902, validation module 158 examines the case number included in the charge sheet data (either on the charge sheet or as manually entered by the administrator, as noted above) and checks the case transaction records in database 114 to determine whether the database contains a corresponding record. If there is no corresponding record, then the surgical facility has submitted a reimbursement request for a case that the transaction entity has not yet approved, and at 908, module 158 (automatically or at the instruction of administrator 106) creates a explanatory message and transmits the message to the surgical facility via interface module 103 and network 112 to computer system 120, at 909. This ends the reimbursement sequence shown in FIG. 9 but does not necessarily end the transaction. For example, surgical facilities sometimes submit charge sheets for surgical procedures for which the surgical facility did not earlier submit a referral. In that event, upon receiving the message at 909, the surgical facility may simply fill out a referral form at step 205 (FIG. 2) and submit the referral at 210 in the same manner as discussed above. The procedures of FIGS. 2, 3, and 4 follow as described above, based on the same data, except that the referral data may additionally include the medical devices actually used in the surgery. On receiving the post-surgery referral, referral module 150 creates a transaction record at 210 that triggers computation of estimated costs and revenue, in the same manner as discussed above with respect to FIG. 4. If the transaction entity has already purchased devices, the case transaction record also has actual cost data (determined based on the charge sheet data, as described below), which creates a cost adjustment and gross profit adjustment, as discussed above. This means that the transaction entity makes the acceptance or denial decision at 414 at least in part based on actual cost data.

At the point in the process at which the transaction entity makes a decision at 414, the system has populated a case transaction record, and the decision at 414 has been recorded in the case transaction record, at 314. If the decision at 414 is to accept the post-surgery case, certain of the device ordering, scheduling, and surgical procedure steps of FIGS. 5-7 may be unnecessary because the surgery has already occurred. Referring again to FIG. 8, if the surgical facility re-submits the charge sheet from step 810, the transaction entity will detect the now-existing case transaction record at 902, and the system operates from that point as it would for a case initially submitted prior to surgery.

If the decision at 902 resulted from inaccurate data submitted by the surgical facility (e.g. if the data does not meet predetermined criteria establishing that it is the kind of data the system expects to see), the surgical facility may revise the charge sheet at 806 or 808 and resubmit the sheet, at 810, thereby triggering another reimbursement cycle.

If the transaction is one for which there is a corresponding transaction record in the database, validation module 158 also determines whether all the devices and procedures are reimbursable by the transaction entity. In the presently-described embodiments, the transaction entity handles transactions for implantable devices but not for other devices that may be needed and used in the surgery, for example non-implantable medical supplies and tools (although, as noted above, the system could be used to manage cases encompassing such devices). Such items should have been excluded from the charge sheet by the sort at 802 (FIG. 8), but if the charge sheet includes a request to reimburse the transaction facility for non-implantable devices, this will generate a notice message at 909. In one embodiment, this does not end the transaction, in that module 158 ignores the non-eligible devices and continues with respect to eligible devices.

At 906, the system checks to determine that the data provided in the charge sheet is complete. Having determined the case number at 902, then at 906 validation module 158 retrieves the case transaction record for that case number, at 314. As indicated above, the transaction record includes the procedure and diagnosis codes associated with the surgical procedure to which the submitted charge sheet corresponds. Based on the insurance information associated with this case transaction record, the transaction entity identifies relationships between procedures and diagnoses (as represented by the CPT and ICD-9 codes in the record) and requirements that that insurer imposes in order to reimburse a claim for an implantable device (i.e. preauthorization requirements, as discussed above). For instance, before making reimbursement for implantable devices related to a hip replacement, an insurance contract may require that the diagnosis information include an assessment of the patient's age and level of athletic activity. Further, the contract (or transaction entity policy) may require supporting invoice data for all costs indicated on a charge sheet (or other cost support, such as a pricing sheet pre-approved by the transaction entity). Thus, at 906, the validation module not only checks to make sure that all of the data expected in the charge sheet is present in the data received from the surgical facility corresponding to the submitted charge sheet, it also determines from the case transaction record (314), based on the procedure and diagnosis codes in that transaction record in view of the pre-authorization data required by the insurance information associated with the record, whether the pre-authorization information required before the insurer will pay a claim for the implantable devices identified in the reimbursement request embodied by the charge sheet is present in the transaction record. In the above example, for instance, the validation module, through GUI 136, presents administrator 106 with a list of the required ancillary information as reflected in the knowledge base. Administrator 106 then reviews the received charge sheet data to determine if the required information is provided, at 912. If not, administrator 106 keys in a request for the needed information in a message captured by case management module 522 and then causes computer system 104 to transmit the message to surgical facility computer system 120 via interface module 103 and network 112, as indicated at 916. Alternatively, the validation module, upon detecting a CPT/ICD-9 code combination requiring ancillary data, and determining from the case transaction record that the ancillary data is not present, the validation module and interface module 103 automatically send a notice to the surgical facility's computer system 120 over network 112, notifying the surgical facility of the need for the ancillary data and that the transaction will not be processed without the data's submission. The surgical facility may add the required information to the charge sheets at 806 or 808 and resubmit the charge sheets at 810.

Module 158 also checks the patient's insurance information to determine if that information establishes an exclusive list of procedures, and/or procedure/diagnosis combinations, and/or implantable medical devices that are covered by the policy, or a list of such things that are excluded from the policy. If such restrictions exist, and if the charge sheet data includes a device, procedure, or procedure/code combination that is not on the former type list or that is on the latter type list, the validation module and interface module automatically send a notice to the surgical facility's computer system 120 over network 112, notifying the surgical facility of the problem and that the transaction will not be processed with the excluded item. The surgical facility may engage in discussion with the insurer to include the item, so that the transaction entity waives the exclusion, but otherwise the transaction proceeded without the excluded item.

If, at 912, the charge sheet information is correct, then at 918 the validation module checks the case transaction record for the present surgical procedure to determine the source of the price at which the transaction entity will reimburse the surgical facility for each implantable medical device identified in the received charge sheet data for which the surgical facility shows a cost.

In the presently-described embodiments, as noted above, the transactions involve insurers, and so the validation module at 918 identifies the insurer associated with this case transaction record and then identifies (from records in database 114) the terms of the agreement between the transaction entity and the insurer (or between the transaction entity and the relevant surgical facility in some instances of a non-commercial payor, as noted above) governing how the transaction entity is to compensate the surgical facility. As noted above, it is possible that there is no relevant agreement between the transaction entity and the surgical facility in case of a given non-commercial payor, and in that event, surgical facility compensation proceeds according to the rules as described below. The sequence of steps in the example illustrated in FIG. 9 assumes the compensation terms will be one of two alternatives—(a) the transaction entity compensates the surgical facility at the surgical facility's actual costs, or (b) the transaction entity compensates the surgical facility at the lower of the surgical facility's costs and the cost to the transaction entity to replace the given device. It should be understood, however, that this is for purposes of explanation and that other arrangements are possible.

As indicated above, for many implantable medical devices, the transaction entity will have previously negotiated a purchase price with the device provider. Accordingly, the transaction entity has created a device/pricing table 921 within database 114 (FIG. 1), comprising records that associate each device provider with which the transaction entity has such an agreement with each implantable medical device for that device provider covered by the agreement, and the agreed-upon price for each device. On the other hand, there are some device providers with which the transaction entity does not have, or cannot reach, an agreement, and thus table 921 has no entries for such devices. Earlier, when the surgical facility submits a pre-surgery or post-surgery case referral to the transaction entity, the referral identifies the physician/surgeon, the surgical procedure, and diagnosis information. Based on this information, the system has predicted the devices that are likely to be used and estimated a cost for the device, as described above. If the device is one for which a provider contract exists, the contract price became the estimated cost. If there was no contract, the system looked back in the database and estimated cost based on historical data.

Having retrieved the insurer contract terms at 918 (or, terms of an agreement between the transaction entity and the relevant surgical facility, in the case of some non-commercial payors, or no agreement data in the case of other non-commercial payors), the validation module determines at 920, for each actually-used implantable medical device (which is identified by manufacturer) in the transaction record arising from the charge sheet data, whether the transaction entity has a pricing contract with the device's provider for that particular device in table 921. If, for a given device, there exists a contract price, then at 922, validation module 158 retrieves the contract price. The validation module then refers to the information in the database regarding the agreement between the transaction entity and the insurer for this case and determines whether that agreement permits the transaction entity to compensate the surgical provider for implantable medical devices based on the lower of the transaction entity cost and the surgical provider's actual cost. If so, the validation module compares the retrieved contract price with cost associated in the data submitted from the charge sheet for that device, selects the lower of the two amounts, and stores the selected amount in the case transaction record as the surgical provider reimbursement amount for that device. Although outside the operation of the presently-described system, the surgical facility may approach the device provider for a discount in the event the transaction entity cost is the lower cost. If the agreement between the transaction entity and the insurer (or, in absence of such agreement, between the transaction entity and the surgical provider) does not allow the transaction entity to use the lower cost, or if there exists no agreement between the transaction entity and either the payor or the surgical facility (e.g. as may be the case with transactions involving some non-commercial payors), then the transaction entity stores the retrieved contract price in the case transaction record as the surgical facility reimbursement amount for the subject medical device. It should be understood that the insurer agreement with the transaction entity may require other pricing methods. For instance, the insurer (or the surgical facility, where the controlling agreement is between the transaction entity and the surgical facility) may require that the transaction entity reimburse the surgical facility according to a pricing schedule previously agreed between the surgical facility and the device provider(s). In that event, the transaction entity stores prices according to the surgical facility/device provider agreement as the surgical facility reimbursement amount for the subject medical devices.

If, for a given medical device at 920, there is no pre-established contract price, then at 924 the validation module retrieves from the case transaction record the surgical facility price associated with the subject device from the charge sheet data. The validation module also checks the information regarding the agreement between the transaction entity and the insurer (or, in some instances in absence of such agreement, information regarding an agreement between the transaction entity and the surgical facility) to determine if the transaction entity is allowed to use the lower of the transaction entity cost and the surgical facility cost. If so, the validation module determines an average price paid by the transaction entity for the same device from the historical transaction records in database 114. By this point in the process, the case will have been through the acceptance procedure described above with respect to FIG. 4. Thus, as noted above, there may be an estimated cost for this device already in the case transaction record, and, if so, the validation module retrieves this estimated cost. If there is no already-estimated cost for this part (for example, because there were insufficient records for the correct surgeon for surgical facility in the earlier analysis), but if there are nonetheless a sufficient number of historical records (for example, ten) having actual costs for the same part, validation module 158 determines the average of these historical costs. Whether selecting an already existing estimated cost or determining a new estimated cost, module 158 compares the estimated cost with the surgical facility's cost for the device from the charge sheet data, selects the lower cost amount, and stores this amount at the case transaction record in association with the subject device as the surgical facility reimbursement amount. If there are insufficient records in the database to determine an estimated cost for the subject device, module 158 stores the surgical facility cost from the charge sheet data as the surgical facility reimbursement amount for the subject device in the transaction record. If the agreement between the transaction facility and the insurer (or between the transaction entity and the surgical facility) does not permit the insurer to select the lower of the transaction facility cost and the surgical facility cost, or if there exists no agreement between the transaction entity and either the payor or the surgical facility, module 158 selects the surgical facility costs from the charge sheet data as the surgical facility reimbursement amount and stores this amount in the transaction record in association with the subject device. Again, if the insurer/transaction entity (or transaction entity/surgical facility) agreement requires some other method of determining the reimbursement price, such as based on a predetermined pricing schedule agreed between the surgical facility and the device provider, the transaction entity uses that price as the surgical facility reimbursement amount for the subject medical device.

Having priced all the devices from the charge sheet data at steps 922 or 924, validation module 158 of case management system 522 examines the data to determine if the medical devices on the submitted charge sheet are valid in view of the procedures performed and diagnoses made. As described above, the acceptance procedure predicts some or all of the medical devices needed for a surgical procedure, and the quantity of each device needed, given the diagnosis, procedure, and other information in the request. This data remains in the case transaction record at the stage of the process reflected by FIG. 9, but at this point, the devices actually used are known and are also part of the transaction record, due to the charge sheet data. The validation module compares the devices and numbers thereof actually used (e.g. nine titanium screws, or one hip replacement kit), as reflected in the charge sheet, to the predicted devices and quantity thereof. If, at 926, each procedure, or procedure/diagnosis combination, corresponds to devices and numbers thereof that match, or at least do not exceed, the predicted devices and quantities in the transaction record as earlier defined, in the acceptance process, then at 928, the validation module calculates new expected transaction entity revenue (i.e., the sum of the implantable device reimbursement amounts (determined as described above with respect to FIG. 4) for the list of actually-used devices from the charge sheets, rather than for the predicted devices. The validation module may enter any relevant notes to the case regarding the revenue, for example any split responsibility between the payor and the patient, and stores the revenue and notes information in the case transaction record.

If any of the procedure codes or diagnosis/procedure code combinations in the charge sheet are linked in the charge sheet data to any implantable devices that are not expected by the predicted data from the acceptance process, or if a device identified in the charge sheet data is in the predicted data but the quantity of the device actually used as reflected in the charge sheet data is higher than the expected quantity for the device in the predicted data from the acceptance process, then from step 926, the validation module notifies the administrator 106 by setting a data flag or providing a message via a GUI 136. The administrator may waive the notice (e.g. the failure to associate a device from the charge sheet data to a predicted device might arise because, as noted above, there was insufficient data upon which to base a prediction in the acceptance process, but the transaction entity administrator may determine the device is valid), thereby continuing with the case at 928 including the noted devices, or the administrator may exclude the problematic devices from the case, so that the case continues at 928 with the remaining devices. The administrator may manually communicate with the surgical facility to notify the surgical facility of the problem. If the transaction entity administrator determines that the noted devices are problematic but that the difficulty can be resolved, for example by submitting medical necessity documentation or an operative report from the surgeon, the surgical facility may resubmit a charge sheet for the previously excluded devices, including the needed information.

At this point, the case transaction record has the actually-used devices that are validated by the transaction entity according to its predetermined criteria. It should be understood, however, that this criteria as described herein is for purposes of example only and may be modified, replaced, or supplemented as desired in a given system or environment. For instance, in a further embodiment, database 114 maintains a table that relates medical devices (by provider/manufacturer number) to an indicator whether the corresponding device provider has indicated the device is no longer available, is obsolete, or has been recalled. If any medical device among the now-validated list of medical devices in the case transaction record is indicated by this table as non-available, obsolete, or recalled, the validation module notifies administrator 106 by setting a flag or providing a message via a GUI 136.

In a still further embodiment, a payor, for example an insurer, may submit claim information for analysis by the transaction entity as described above with respect to step 924. For example, assume a surgical procedure has occurred in which the transaction entity is uninvolved but for which a surgical facility has submitted a reimbursement claim to an insurer. The reimbursement claim will comply with the insurer's data requirements. Those data requirements are unlikely to exactly match the data format of a case transaction record of case management system 522 of the presently-described system, but the claim data should include HCPCS/DRG codes, diagnosis ICD-9 codes, and procedure CPT codes, and may include the implantable medical devices used in the procedure, the quantity of each device used, and the amount the surgical provider claims from the payor in reimbursement for medical devices used in the procedure. The insurer may submit this claim information, along with details of the patient's insurance policy, to the transaction entity system for analysis against the transaction entity's knowledge base. Similar to the procedure described above with respect to FIG. 4, the validation module receives the claim data, retrieves the ICD-9 codes, CPT codes, surgeon identity, and surgical facility identity from the claim data and, as described above, develops a list of expected implantable medical devices and the quantity of such devices. The module may report the expected/predicted medical devices to the insurer but may also compare the predicted devices to the actually-used devices and report the comparison to the insurer. The validation module estimates costs based on the predicted devices (and the predicted quantity of such devices). The module may output the estimated cost to the insurer but may also compare the estimated costs to the amounts requested in the claims and reports the comparison to the insurer. The module may also compare the ICD-9/CPT code combinations with the HCPCS/DRG codes associated with the code combinations in database 114 to confirm that the associations between code combinations and HCPCS/DRG codes in the submitted claim information have corresponding relationships in the database. If not, the transaction entity reports the discrepancy to the insurer. The module may also compare the devices, procedures, and procedure/diagnosis combinations in the submitted claim information to any exclusions in the patient's insurance coverage, as described above, to detect whether the claim includes any excluded items. If so, the transaction entity reports the discrepancy to the insurer. The report(s) may be automatically output to the insurer or simply noticed to the transaction entity administrator, who then manually notifies the insurer. Discrepancies can be reported on a per-case basis and/or shown as part of trending information on a time-period basis.

Returning to FIG. 8, at 816, billing module 160 (FIG. 1) generates any replenishment orders needed to reimburse the surgical facility for implantable medical devices used by the surgical facility at the surgical facility's expense. As noted above, in the presently described embodiments, this occurs because the surgical facility uses one or more medical devices out of its existing inventory, orders and pays for the medical devices directly, or purchases one or more devices from a device provider representative at the surgery. The charge sheet data includes fields by which the surgical facility indicates, for each device or globally for all or a group of actually-used devices, whether the surgical facility requests that the transaction entity replace the device(s) or monetarily compensate the surgical facility for the device and whether, if the surgical facility requests replacement, the surgical facility wishes the transaction entity to directly order the device for shipment to the surgical facility or to provide the surgical facility a purchase order by which the surgical facility will order the device. Accordingly, billing module 160 determines, at 817, if the device is a replenishment device and, if so, whether, under the arrangement with the surgical facility, the transaction entity submits purchase orders directly to the device provider. If the answer to both questions, is “yes,” then order creation module 157 generates an electronic purchase order, directed to a device manufacturer (in one embodiment, such direct purchase orders are used only where the device provider is a manufacturer, but this is not a requirement), and, via interface module 103 and network 112, transmits the purchase order directly to the device provider, as indicated at 818. The purchase order directs the device provider to ship the device directly to the surgical facility and to submit an invoice to the transaction entity. If the surgical facility uses a form provided by the transaction entity, the form may be pre-printed with the case number to allow a direct confirmation. Otherwise, if the surgical facility uses its own charge sheet, the transaction entity administrator determines the case number by associating the surgery date and the patient with a case record.

If the answer to either question at 817 is “no,” billing module 160 checks, at 820, whether the device is a replenishment device and, if so, whether, under the arrangement with the surgical facility the transaction entity generates purchase orders for the surgical facility. If the answer to both questions is “yes,” order creation module 157 generates a purchase order and, via interface module 103 and network 112, transmits the electronic purchase order to surgical facility computer system 120. The purchase order, which the surgical facility submits to the device provider, instructs the device provider to ship the device, or have the device shipped, to the surgical facility and to submit an invoice to the transaction entity.

If the answer to either question at 820 is “no,” billing module 160 then checks the case transaction record for the device at issue to determine if it is a replenishment device and, if so, if the surgical facility has requested monetary compensation rather than replenishment of the part to inventory. If the answer to both questions at 822 is “yes,” then at 823, billing module 160, via interface module 103 and network 112, initiates an automated clearing house (ACH) procedure to transfer an amount of money from an account owned or controlled by the transaction entity to an account owned or controlled by the surgical facility that corresponds to the device price determined at step 922 or 924 (FIG. 9), as described above. The system may aggregate payments for all applicable devices in a given transaction, or may make payments on a device-by-device basis.

If the answer to either question at 822 is “no,” then the device is not a replenishment device. Regardless, module 157 updates the case transaction record to reflect whether the surgical facility has been compensated for each actually-used device and, if so, in what manner

FIG. 10 illustrates a billing portion of a method for facilitating a transaction is accordance with an embodiment of the present invention, utilizing case management module 522 and its billing module 160 (FIG. 1). As described above, in certain transactions, or for certain devices within a particular transaction, the transaction entity submits purchase orders directly to the device provider, and in other instances the surgical facility submits purchase orders with recourse to the transaction entity. In those instances, the device provider invoices the transaction entity, thereby creating accounts payable on the transaction entity's accounting system. Data for this account payable information, and for any payments made by the transaction entity on such accounts, are stored in the case transaction record for the transaction, in database 114. Similarly, where the transaction entity forwards purchase orders to the surgical facility, and the surgical facility orders and pays for the devices and reflects these charges in a charge sheet the surgical facility submits to the transaction entity at 810 (FIG. 8), the charges the transaction entity system accepts (as discussed above with respect to FIG. 9) become accounts payable, and the transaction entity stores data for the account and for compensation made to the surgical facility (FIG. 8) in the corresponding transaction record. As indicated above, with regard to FIG. 8, compensation may take the form of device replenishment or direct payments to the surgical facility. In any event, at this point the transaction entity has paid for all the implantable medical devices used in a surgery that the transaction entity has approved.

Also as described above, the transaction entity has received from the insurer the insurance contract information that will govern the insurer's obligations with respect to the case regarding the devices for which the insurer will provide reimbursement and the reimbursement value. This information is also stored in or in association with the case transaction record. For example, the insurer/transaction entity agreement terms may define reimbursement amounts at the HCPCS/DRG code level, or the CPT code level. As discussed above, the transaction entity has established in the knowledge base relationships between each CPT/ICD-9 code combination that supports an implantable medical device-related HCPCS/DRG code and the respective code. Thus, where the insurer agreement requires claims be filed on an HCPCS/DRG code basis, the system determines the HCPCS/DRG codes applicability to a transaction record based on the validated ICD-9/CPT code combinations in the transaction record and prepares an appropriate claim based on these codes. Alternatively, the insurer may require claims to be submitted on a CPT/ICD-9 code basis, and in that event the system prepares claims based directly on the validated CPT/ICD-9 combinations in the transaction record. Further, for example where, as explained above, an insurer requires the transaction entity to reimburse the surgical facility based on a per-device pricing schedule, the insurer agreement (or surgical facility agreement) with the transaction facility may provide for claim reimbursement on a per-device basis, for example according to a predetermined per-device pricing schedule (e.g. set between the surgical facility and the device provider(s) or on a cost-plus basis, where “cost” is the transaction entity's reimbursement cost to the surgical facility. Still further, the insurer may reimburse claims on a per-device per-unit or cost-plus basis regardless of the method used to determine surgical facility reimbursement costs.

At 1052, transaction entity administrator 106, via computer 104 and GUI 136, activates billing module 160 to retrieve the payment information corresponding to the device for a given transaction (i.e. the amount to be submitted in a claim to the insurer, along with any corresponding information required for the claim process per the insurance company's requirements, and any amount to be billed to the patient with corresponding information needed for the statement process) from the case transaction record on database 114. Billing module 160 also retrieves from the transaction record shipping costs and taxes paid by the transaction entity for medical devices ordered directly by the transaction entity. Shipping costs and taxes are reflected on invoices received by the transaction entity from the device providers and are entered, along with the device price, on the transaction record as the transaction entity's actual costs for a given device.

Billing module 160 extracts this data from the database at 1050 and at 1054 prepares claims to the insurer and statements to the patient. The manner of this billing depends upon the transaction entity's internal policies and arrangements or agreements between the transaction entity and the insurer. For example, billing module 160 may control a printer module to print hardcopy claims/statements at a printer (129) for mailing to the insurer/patient, or the system may submit these items electronically. In particular, with regard to an insurer, the transaction entity prepares claims according to the insurer's claims process to recover the charges in the form of claims 1057, as indicated at 1056. The insurer may send confirmation back to the surgical facility that the claim has been accepted, as indicated by the dual arrow between blocks 1056 and 1057.

It is possible, because either the transaction entity or the insurer determines further information is needed, that the claims process is interrupted in order to obtain further information from the surgical facility. For example, the surgical facility may submit a case to the transaction entity for reimbursement for a surgery that has already occurred, but for which the transaction entity has not approved a transaction through the processes described above. When this happens, the transaction entity administrator activates the case management module to create a case transaction record, but the transaction record is incomplete at least in that there is no transaction entity approval (see steps 414, 418, and 314, FIG. 4A). When billing module 160 detects the incomplete transaction record at 1054, the billing module, rather than submitting a claim at 156, submits the case information back to module 152 for evaluation, at step 902 (FIG. 9), described above. This ends the present transaction but, as described above, should cause completion of the transaction record so that the claim may be later submitted as described herein. Additionally, the insurer company may determine in its claim evaluation process at 1057 that the claim information submitted by the transaction entity is incomplete. The insurer sends a message back to computer system 102, via network 112 and interface module 103, to billing module 160 (indicated by the arrow between step 1057 and step 1056), indentifying the charges/devices for which further information is needed. This causes billing module 160, at step 1060, to resubmit the requested charges/devices to the charge analysis process described above with respect to FIG. 9. Again, this ends the claim process until the transaction record is completed.

It is also possible that, at 1057, the claim request may be complete but the insurer refuses responsibility for the claim. In that event, as indicated at 1010, the insurer and the transaction entity may participate in an appeal process, as is well known in the insurance industry. The present discussion assumes that the outcome of appeal will be either that the insurer has no liability for the claim or does have liability. If the former, the transaction entity may pursue payment of the patient portion of the total but cannot collect the insurer portion. If the latter, the process proceeds.

If the insurer approves the claim, and so notifies the transaction entity, as indicated by the arrow between 1057 and 1056, the claims to the insurance company and the statement to the patient now comprise accounts receivable from the transaction entity's perspective. Accordingly, at 1058, the transaction entity posts the accounts receivable information to a transaction entity receivable record 1071 in database 114. This record is linked to the case transaction record for the corresponding case and identifies the payor (e.g. the insurance company and/or the patient). By maintaining this record and updating for payor payments, the transaction entity tracks the amounts owing from each given party, e.g. for collection purposes.

At 1062, drawing from an insurer account 1064, the insurer makes a payment to the transaction entity, as indicated at 1066, for example by check or automated clearing house (ACH) payment. Billing module 160 then posts the payment to the transaction entity receivable record 1071, as indicated at 1058. Similarly, to the extent the patient owes a portion of the charges, and drawing from patient funds 1070, the patient submits payment to the transaction entity, for example, by check or ACH payment, as indicated at 1072 and 1066. Again, billing module 160 posts such payments to the transaction entity receivable record 1071 for this case, as indicated at 1058.

Once the transaction entity receives all funds from the insurer and/or patient due for a particular case, the transaction entity administrator, via GUI 136 and billing module 160, closes the case at 1068 by updating the transaction entity receivable record to indicate that all claims in the invoices for the case have been fully paid.

As will be appreciated by one of skill in the art, the present invention may be embodied as a method (including, for example, a computer-implemented process, apparatus (including, for example, a system, machine, device, computer program product, and/or the like), or a combination of the foregoing. Embodiments of the present invention may take the form of an entirely software embodiment or an embodiment combining software and hardware aspects. Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

As noted, embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A method of facilitating a transaction among a surgical provider, a medical device provider, and a payor, involving medical devices needed for a surgical procedure to be conducted by the surgical provider, comprising the steps of:
at a computer system accessible by a plurality of surgical providers remote from the computer system, receiving from a surgical provider of the plurality of surgical providers procedure identification and diagnosis information related to the surgical procedure;
at the computer system, predicting one or more medical devices for use in the surgical procedure based on the procedure identification information and the diagnosis information;
at the computer system, estimating a cost for an entity that controls the computer system to provide medical devices to the surgical provider, based on at least one of the one or more medical devices predicted at the predicting step and the procedure identification information received at the receiving step;
at the computer system, estimating a revenue to the entity, based on a predetermined reimbursement relationship between the entity and at least one of the payor and the surgical provider;
at the computer system, receiving information from the surgical provider identifying medical devices actually used in the surgical procedure after the surgical procedure has been performed;
from the computer system, transmitting instructions to reimburse the surgical provider for costs borne by the surgical provider for medical devices actually used in the surgical procedure; and
submitting, from the computer system, a request to the payor for reimbursement of the entity for costs borne by the entity for medical devices actually used in the surgical procedure.

2. The method of claim 1, wherein the cost estimated at the estimating step is also based on data identifying costs to the entity for the one or more medical devices in past procedures.

3. The method of claim 2, wherein the procedure identification information comprises identification of a surgeon who will perform the surgical procedure, and wherein the cost estimated at the estimating step is also based on data indentifying costs to the entity for one or more medical devices in past procedures performed by the surgeon.

4. The method of claim 3, wherein the cost estimated at the estimating step is also based on predetermined cost relationship comprises data identifying costs to the entity for the one or more medical devices in past procedures performed at the surgical facility.

5. The method of claim 1, wherein the cost estimated at the estimating step is also based on data identifying cost to the entity for providing medical devices in past transactions for a procedure identified in the procedure identification information received at the receiving step.

6. The method of claim 1, further comprising delivering the one or more medical devices to the surgical provider.

7. The method of claim 1, further comprising, following the receiving information step, estimating a range of medical devices expected to be used in the surgical procedure having the procedure identification, based on data identifying use of medical devices in prior surgical procedures, and detecting existence of inconsistency between the medical devices actually used and the range.

8. The method of claim 1, wherein the transmitting step comprises transmitting a purchase order to a device provider to provide one or more medical devices to the surgical provider corresponding to the actually-used medical devices giving rise to the costs borne by the surgical provider.

9. The method of claim 1, wherein the transmitting step comprises transmitting a purchase order to the surgical provider configured to request purchase of one or more medical devices corresponding to the actually-used medical devices giving rise to the costs borne by the surgical provider.

10. The method of claim 1, wherein the transmitting step comprises transmitting a payment request to a financial institution to transfer an amount corresponding to the cost borne by the surgical provider from an account controlled by the entity to an account controlled by the surgical provider.

11. A computer system comprising:
a computer processor;
computer-readable medium; and
one or more software modules stored on the computer-readable medium, the modules configured to perform a method of facilitating a transaction among a surgical provider, a medical device provider, and a payor, involving medical devices needed for a surgical procedure to be conducted by the surgical provider, the method comprising
receiving from a surgical provider of a plurality of surgical providers procedure identification and diagnosis information related to the surgical procedure;
predicting one or more medical devices for use in the surgical procedure based on the procedure information and the diagnosis information;
estimating a cost for an entity that controls the computer system to provide medical devices to the surgical provider, based on at least one of the one or more medical devices predicted at the predicting step and the procedure identification information received at the receiving step;
estimating a revenue to the entity based on a predetermined reimbursement relationship between the entity and at least one of the payor and the surgical provider;
receiving information from the surgical provider identifying medical devices actually used in the surgical procedure after the surgical procedure has been performed;
transmitting instructions to reimburse the surgical provider for costs borne by the surgical provider for medical devices actually used in the surgical procedure; and
submitting a request to the payor for reimbursement of the entity for costs borne by the entity for medical devices actually used in the surgical procedure.

12. The system of claim 11, wherein the method further comprises submitting a purchase order for the one or more medical devices from the computer system to a medical device provider of the one or more medical device providers.

13. The system of claim 11, wherein the method further comprises receiving a surgical report from the surgical provider, the surgical report comprising the medical devices actually used in the surgical procedure.

14. The system of claim 13, wherein the step of identifying medical devices actually used in the surgical procedure comprises estimating a range of medical devices expected to be used in the surgical procedure, based on data identifying use of medical devices in prior surgical procedures, and detecting existence of inconsistency between the medical devices actually used based on the surgical report, and the range.

15. The system of claim 11, wherein the transmitting step comprises transmitting a purchase order to a device provider to provide one or more medical devices to the surgical provider corresponding to the actually-used medical devices giving rise to the costs borne by the surgical provider.

16. The system of claim 11, wherein the transmitting step comprises transmitting a purchase order to the surgical provider configured to request purchase of one or more medical devices corresponding to the actually-used medical devices giving rise to the costs borne by the surgical provider.

17. The system of claim 11, wherein the transmitting step comprises transmitting a payment request to a financial institution to transfer an amount corresponding to the cost borne by the surgical provider from an account controlled by the entity to an account controlled by the surgical provider.

18. A method of facilitating a transaction among a surgical provider, a medical device provider, and a payor, involving medical devices needed for a surgical procedure to be conducted by the surgical provider, comprising the steps of:
providing a database
that relates past surgical procedures and corresponding diagnosis information to one or more medical devices used in each respective post surgical procedure,
that relates the one or more medical devices to respective costs to provide the one or more medical devices to a surgical provider, and
that relates the one or more medical devices to reimbursement amounts payable by the payor;
at a computer system accessible by a plurality of surgical providers remote from the computer system, receiving from a surgical provider of the plurality of surgical providers data identifying a patient, a surgical procedure to be performed on the patient, diagnosis information relating to the patient and corresponding to the procedure, and identification of a surgeon to perform the surgical procedure;
at the computer system, estimating at least one medical device needed for the surgical procedure identified at the receiving step based on the surgical procedure data and diagnosis information data received at the receiving step and a relationship between the past surgical procedures and corresponding diagnosis information and the one or more medical devices used in each respective past surgical procedure;
at the computer system, relating the at least one medical device identified at the estimating step to a said respective cost based on the database;
at the computer system, relating the at least one medical device identified at the estimating step to a said reimbursement amount based on the database;
at the computer system and following performance of at least one surgical procedure, receiving information from the surgical provider identifying the at least one surgical procedure and at least one medical device actually used in the at least one surgical procedure;
at the computer system and in response to the information received from the surgical provider identifying the at least one actually used medical device, determining a compensation amount corresponding to the actually used medical device and generating an instruction to compensate the surgical provider based on the compensation amount; and
submitting, from the computer system, a request to the payor for reimbursement of the entity based on the actually used medical device.

19. The method as in claim 18, wherein the database defines predetermined prices for medical devices and wherein the step of relating the at least one medical device identified at the estimating step to a said respective cost is based on a said predetermined price for the at least one medical device or, in absence of a said predetermined price, upon and average of past prices paid for the at least one medical device as stored in the database.

20. The method as in claim 18, wherein the database relates patients to payors, and wherein the database defines a relationship relating procedures and payors to reimbursement amounts based on the procedures and upon predetermined agreement by the payors, and wherein the step of relating the at least one medical device identified at the estimating step to a said reimbursement amount based on the database comprises relating the procedure information to the reimbursement amount based on the relationship.

21. The method as in claim 18, wherein the database defines a relationship that relates procedures to respective diagnoses that result in the procedures, and wherein the database defines average occurrence of devices for each combination of procedure and related respective diagnoses, and wherein, for each transaction, the step of estimating the at least one medical device comprises comparing the surgical procedure data and the diagnosis information data to the relationship so that the at least one medical device corresponds to a said average occurrence.

22. The method as in claim 18, wherein
the database
relates procedures to respective diagnoses that result in the procedures,
identifies occurrences of procedures in presence of respective diagnoses in past transactions, and
relates the occurrences with an identity of a respective surgeon who performed the procedure in each occurrence,
wherein the first receiving step includes receiving information identifying a first surgeon who will perform the surgical procedure identified in the first receiving step, and
wherein the method further comprises
determining a past rate of occurrence of procedures in the presence of respective diagnoses, based on the database,
determining a rate of occurrence of the surgical procedure identified in the first receiving step in presence of the diagnoses and the first surgeon identified in the first receiving step, and
comparing the rate of occurrence of the surgical procedure identified in the first receiving step with a said past rate of occurrence of the procedure identified in the first receiving step.

23. A method of facilitating a transaction between a surgical provider and a payor, involving medical devices used for a surgical procedures conducted by the surgical provider and for which a reimbursement request has been submitted by the surgical provider to the payor, comprising the steps of:
at the computer system accessible by the payor and a plurality of other payors, each of which is remote from the computer system, receiving from the payor procedure identification and diagnosis information related to the surgical procedure;
at the computer system, estimating a cost to provide medical devices to the surgical provider, based on at least one of an identification of one or more medical devices for use in the surgical procedure and the procedure identification information received at the receiving step; and
outputting to the payor information related to at least one of the medical devices predicted at the predicting step and the cost estimated at the estimating step.

24. The method as in claim 23, further comprising, at the computer system, receiving from the payor information identifying an amount the surgical provider requests from the payor based on medical devices used in the surgical procedure, and wherein the information output to the payor in the outputting step includes a comparison of the amount to the cost estimated at the estimating step.

25. The method as in claim 23, further comprising, at the computer system, receiving from the payor information identifying one or more medical devices actually used in the surgical procedure, and wherein the information output to the payor in the outputting step includes a comparison of the actually-used one or more medical devices to the one or more medical devices.
